(19) United States
(12) Patent Application Publication
(10) Pub. No.: US 2026/0308335 A1
(43) Pub. Date: Oct. 8, 2026

(54) FUNCTIONALIZED LIGNIN, A METHOD FOR PREPARATION THEREOF AS WELL AS USES THEREOF

(71) Applicant: AB KARL HEDIN BIO INNOVATION, Uppsala (SE)

(72) Inventors: Johan Gising, Uppsala (SE); Jonas Lindh, Uppsala (SE); Maxim Galkin, Uppsala (SE)

(21) Appl. No.: 19/481,952

(22) PCT Filed: May 8, 2024
(86) PCT No.: PCT/EP2024/062740

§ 371 Date: Nov. 6, 2025

(30) Foreign Application Priority Data
May 8, 2023 (SE) 2350558-9

(51) Int. Cl. C08H 7/00

(52) U.S. Cl. CPC C08H 6/00

(57) ABSTRACT

Described is lignin comprising β-O-4′ units binding at the α position to one or more compounds of Formula I such as phenol, catechol, resorcinol, hydroquinone, pyrogallol and/or guaiacol, a method for preparation thereof as well as uses thereof.

### TECHNICAL FIELD

The present invention relates to functionalized lignin. More specifically the present invention relates to lignin that is covalently bonded at the α position of its β-O-4′ units to phenyl derivatives such as phenol, catechol, resorcinol, hydroquinone, pyrogallol and/or guaiacol, a method for preparation thereof as well as uses thereof.

### BACKGROUND

The increased awareness of the negative impact of global warming has prompted the development of new and more sustainable products and materials. In particular, fossil-free and renewable materials based on biomass have attracted much attention, and new areas of research focusing on the re-evaluation and valorization of materials previously considered to be of low value are emerging.

Lignin is a wood component that was previously considered to be of little use. In the pulp and paper industry it was regarded as a by-product and therefore frequently incinerated during cellulose pulp processing. With the rise of biomass-based ethanol production, lignin also became a by-product as a result of the hydrolysis taking place. However, lignin is now found to be a very promising resource despite significant challenges associated with its valorization.

Lignin is the second most abundant natural polymer after cellulose and is found in the cell walls of most land plants. Lignin constitutes from 15% to 35% of most biomass of higher plants. In trees, lignin constitutes from 20% to 35% where it acts as a binder for the cellulose and hemicellulose. Lignin has a complex aromatic chemical structure which depends on its origin and how it has been obtained. While the phenolic structures in hardwood lignin mainly are coniferyl (G) and sinapyl(S), softwood lignin almost exclusively contains coniferyl (G) phenolic structures, and grasses contain p-coumaryl (H), coniferyl (G), and sinapyl(S) phenolic structures. These phenolic structures are commonly denominated C9 units and may be referred to when characterizing lignins.

The challenges of lignin valorization involving extraction and/or isolation include the frequent degradation such as fragmentation, cleavage or (re) condensation of the lignin when it is prepared using fractionation of lignocellulosic compositions. This is due inter alla to the fact that the β-O-4′ linkage in native lignin is very labile and subjected to fragmentation during processing, which leads to the release of very reactive species resulting in recondensation of the lignin. As a result, the β-O-4′ linkage present in native lignin is not present, or present to a very limited extent, in most industrially produced lignin. This is very unfortunate, since the β-O-4′ linkage is an important starting point for further functionalization of the lignin to provide lignin-based materials with various desired properties.

In order to overcome the problems with lignin valorization, improved methods for processing lignocellulosic biomass to avoid lignin degradation such as fragmentation, cleavage or (re) condensation must be developed or ways of dealing with highly condensed or industrial lignin must be found.

Efforts have been made to provide methods of processing lignocellulose that preserve the chemical structure of the lignin and make it accessible for further functionalization.

US 2021/0130554 A1 discloses a method of processing a lignocellulosic feedstock which includes heating the lignocellulosic feedstock in a solvent mixture comprising an acid and at least 80% by volume of n-butanol to produce a reaction mixture including a butylated lignin. It is described that a butylated lignin product wherein 85% of the β-O-4′ linkages include n-butyl ether groups can be prepared. Further, it is described that cellulose and butylated hemicellulose products can be prepared.

EP 3 808 755 A1 discloses a method for producing fragments of lignin with functional groups. The functional groups may be selected from aldehyde, carboxylic acid, nitrile, ether, thioether, hydroxyl, thiol, nitro, chloride, bromide, iodide, azide, and triflate.

ACS Sustainable Chem. Eng. 2020, 8, 2772-2782 discloses a mild one-pot lignocellulose fractionation based on acid-catalyzed biphasic water/phenol system to enhance the components' processability. Three phases were obtained, namely a water phase containing hemicellulose-derived sugars, a phenol phase containing lignin, and a cellulose-enriched solid phase. The lignin was used together with the phenol solvent without further separation to prepare a lignin-based phenolic foam.

It is known that the amount of aromatic hydroxy groups in lignin is crucial in many applications. For example, the epoxy resin activity, redox activity, antimicrobial activity, UV blocking properties are improved when the amount of aromatic hydroxy groups of the lignin is increased. Unfortunately, however, lignin comprising a high amount of aromatic hydroxy groups, which is suitable for use in relation to advanced materials has been found difficult to prepare. Furthermore, current production and methods of preparation do not satisfy the need on the market.

Therefore, there is a need for methods allowing to prepare lignin comprising a high amount of aromatic hydroxy groups. In particular, there is a need for methods allowing to prepare lignin comprising a high amount of aromatic hydroxy groups while also minimizing or eliminating lignin degradation such as fragmentation, cleavage or (re) condensation and/or formation of by-products and preferably also being compatible with common biorefinery processes. There is also a need for providing lignin with a well defined chemical structure allowing for controlling its properties.

### SUMMARY

It is an object of the present invention to overcome or at least mitigate one or more of the aforementioned problems. It is also an object of the present invention to provide aspects and/or advantages not provided by hitherto known techniques.

Thus, there is provided an article according to independent claim 1, lignin according to independent claim 18, the use according to independent claim 19 and the method according to independent claim 20. Embodiments are set forth in the appended dependent claims and in the following description and examples.

### BRIEF DESCRIPTION OF THE DRAWINGS

FIG. 1 shows the lignin yield as a function of the acid concentration as shown in Example 2.

FIG. 2 shows the ¹H/¹³C HSQC/HMBC NMR spectrum for compound A in Example 4.

FIG. 3 shows the ¹H/¹³C HSQC NMR spectrum for compound B in Example 4.

FIG. 4A shows the ¹H/¹³C HSQC NMR spectrum for compound A in Example 4.

FIG. 4B shows the ¹H/¹³C HSQC NMR spectrum for functionalized lignin D in Example 4.

FIG. 5 shows the ¹H/¹³C HSQC/HMBC NMR spectrum for compound C in Example 4.

FIG. 6A shows the ¹H/¹³C HSQC NMR spectrum for compound C in Example 4.

FIG. 6B shows the ¹H/¹³C HSQC NMR spectrum for the functionalized lignin E in Example 4.

FIG. 7 shows the current as a function of the electrode potential in Example 7.

FIG. 8 shows the current as a function of the electrode potential for lignin functionalized with hydroquinone before and after activation of catechin groups in Example 7.

FIG. 9 shows the capacity of lignin fragments with varying amount of covalently bound hydroquinone.

### DESCRIPTION

The invention provides an article comprising or consisting of:
(i) lignin; and
(ii) one or more compounds of Formula I:

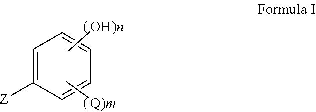

wherein
Q is independently selected from the group consisting of C₁-C₁₈alkyl, C₂-C₁₈alkene, OC₁-C₁₈alkyl, OC₂-C₁₈alkene, COOH, COOC₁-C₁₈alkyl, OCOC₁-C₁₈alkyl, COOC₂-C₁₈alkene, OCOC₂-C₁₈alkene, SO₃H and SH;
Z is H or

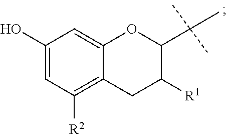

R¹ and R² are independently selected from the group consisting of H, OH, C₁-C₁₈ alkyl, C₂-C₁₈alkene and

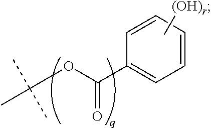

n is 1, 2 or 3;
m is 0, 1 or 2;
r is 2 or 3; and
q is 0 or 1
said lignin being covalently bonded at the α position of the lignin β-O-4′ units to the phenyl ring of the one or more compounds of Formula I;
wherein
about 90% or more of the lignin β-O-4′ units bind at the α position to the phenyl ring of the one or more compounds of Formula I; and
the lignin β-O-4′ units binding at the α position to the phenyl ring of the one or more compounds of Formula I are present within the range of from about 10% to about 50% per 100 C9 units of the lignin.

The term “C₁-C₁₈alkyl” denotes a saturated alkyl group, which may be straight, branched or cyclic, said alkyl group comprising one to eighteen carbon atoms. Examples of “C₁-C₁₈alkyl” include, but are not limited to, methyl, ethyl, n-propyl, isopropyl, n-butyl, sec-butyl, iso-butyl, tert-butyl, n-pentanyl, isopentyl, neopentyl, n-hexyl, isohexyl, 3-methylpentyl, 2,3-dimethylpentyl, neohexyl, cyclohexyl, heptyl, cycloheptyl, isoheptyl, 3-methylhexane, n-heptyl and isomers thereof, n-octyl and isomers thereof, n-nonyl and isomers thereof, decyl and isomers thereof, tetrahydrogeranyl, n-dodecyl, n-tridecyl, n-tetradecyl, n-pentadecyl, n-hexadecyl, n-octadecyl. Further, the C₁-C₁₈alkyl group may be a residue such as a carbon chain of a fatty acid or fatty alcohol.

The term “C₂-C₁₈alkene” denotes an alkene group, which may be straight, branched or cyclic, comprising two to eighteen carbon atoms. Examples of “C₂-C₁₈alkene” include, but are not limited to, ethylene, vinyl, allyl, butenyl, pentenyl, hexenyl, heptenyl, octenyl, nonenyl, or isomers of the foregoing. Further, the C₂-C₁₈alkene group may be a residue such as a carbon chain of a fatty acid or fatty alcohol.

The term “OC₁-C₁₈alkyl” denotes a C₁-C₁₈alkyl group as described herein which is linked to an oxygen atom.

The term “OC₂-C₁₈alkene” denotes a C₂-C₁₈alkene as described herein which is linked to an oxygen atom.

The term “COOC₁-C₁₈alkyl” denotes an ester in which the C₁-C₁₈alkyl group is linked to the oxygen of the alkoxy group of the ester. The term “OCOC₁-C₁₈alkyl” denotes an ester in which the C₁-C₁₈alkyl group is linked to the carbonyl of the ester.

The term “COOC₂-C₁₈alkene” denotes an ester in which the C₂-C₁₈alkene group is linked to the oxygen of the alkoxy group of the ester. The term “OCOC₂-C₁₈alkene” denotes an ester in which the C₂-C₁₈alkene group is linked to the carbonyl of the ester.

It is a significant advantage that 90% or more of the lignin β-O-4′ units of the article bind at the α position to the one or more compounds of Formula I as this allows for a well defined article with specific properties. For instance, about 95% or more, such as about 97% or more, such as about 99% or more all of the lignin β-O-4′ units of the article may bind at the α position to the one or more compounds of Formula I.

Any suitable spectroscopic technique may be used for determining the percentage of lignin β-O-4′ units binding a the α position to the one or more compounds of Formula I. For instance, Nuclear Magnetic Resonance (NMR) may be used for determining the percentage of lignin β-O-4′ units binding at the α position to the one or more compounds of Formula I.

Advantageously, the article and/or lignin described herein may comprise very little or no native or (re) condensed lignin thereby further improving the definition and properties of the article and/or lignin. For instance, the article and/or lignin may comprise about 5% or less such as 0% of β-O-4′ units of Formula A:

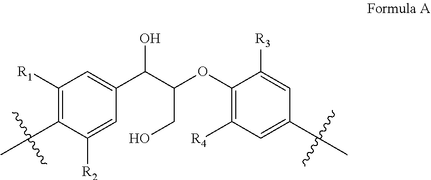

wherein R₁, R₂, R₃ and R₄ independently are H or OCH₃.

Additionally or alternatively, the article and/or lignin may comprise about 5% or less such as 0% of units of Formula B and/or units of Formula C:

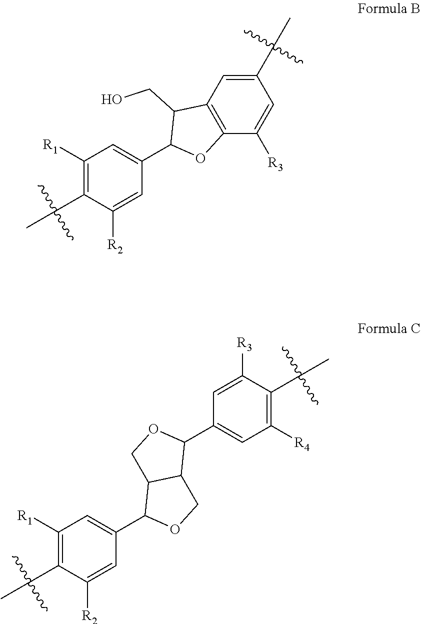

wherein R₁, R₂, R₃ and R₄ independently are H or OCH₃.

Further, there is provided an article as described herein wherein the one or more compounds of Formula I is not phenol.

The value for Z in the compound of Formula I may be H, i.e. hydrogen, thereby providing a compound of Formula Ia:

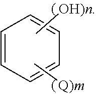

Examples of the compound of Formula Ia include anacardic acid, cardanol and/or cardol:

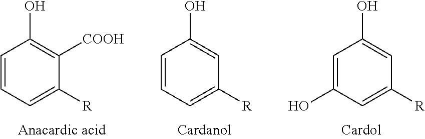

wherein the R group is C₁-C₁₈alkyl or C₂-C₁₈alkene as described herein.

Alternatively, the value for Z in the compound of Formula I may be

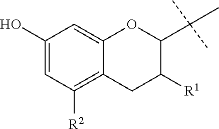

thereby providing a compound of Formula Ib:

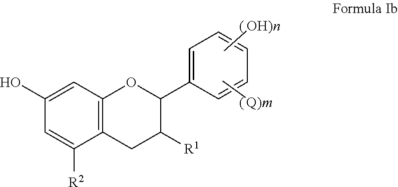

wherein R¹ and R² are as described herein
or a stereoisomer thereof.

For example, the stereoisomer of Formula Ib may be a trans stereoisomer of Formula Ib1 or a cis stereoisomer of Formula Ib2:

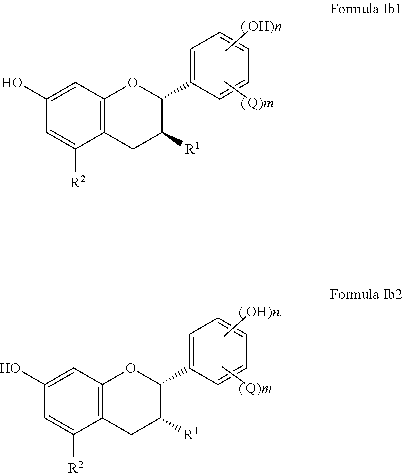

Examples of the compound of Formula Ib include (+)-catechin, (−)-epigallocatechin, (−)-epicatechin, (−)-epicatechin-3-gallate and/or (−)-epigallocatechin-3-gallate.

It will be appreciated that the lignin covalently binds at the α position of the lignin β-O-4′ units to the phenyl ring of the one or more compounds of Formula I. Thus, the covalent bonding takes place via the carbon at the α position of the lignin β-O-4′ units so that the carbon binds to the phenyl ring of the compound of Formula I, i.e. the phenyl ring carrying the OH, Q and Z substituents. This is illustrated below for the functionalized lignin fragment 1 binding to the compound of Formula I and for the lignin fragment 2 wherein the compound of Formula I is a catechol.

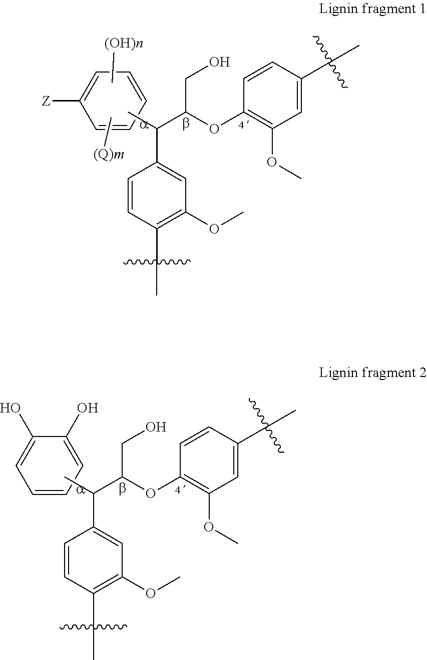

The one or more compounds of Formula I may be present within the range of from about 20% to about 40%, such as from about 20% to about 35%, such as from about 25% to about 35%, such as about 30% in the α position of the lignin β-O-4′ units per 100 C9 units of the lignin. In particular, the one or more compounds of Formula I may be present within the range of from about 20% to about 40% per 100 C9 units of the lignin. In other words, the lignin β-O-4′ units binding at the α position to the one or more compounds of Formula I may be present within the range of from about 20% to about 40%, such as from about 20% to about 35%, such as from about 25% to about 35%, such as about 30% per 100 C9 units of the lignin. In particular, the lignin β-O-4′ units binding at the α position to the one or more compounds of Formula I may be present within the range of from about 20% to about 40% per 100 C9 units of the lignin.

Examples of the compound of Formula I include, but are not limited to, catechol, resorcinol, hydroquinone, pyrogallol, guaiacol. Thus, the compound of Formula I may be catechol, resorcinol, hydroquinone, pyrogallol or guaiacol taken alone or a mixture of two or more of the aforementioned compounds. In an example, the compound of Formula I does not comprise or consist of phenol.

The values for n may be 2 or 3 and the value for m may be 0 for the compound of Formula I described herein. For example, the compound of Formula I may be one or more of the following: catechol, resorcinol, hydroquinone, pyrogallol. When the value of n is 2 and the value of m is 0 the compound of Formula I may be catechol, resorcinol and/or hydroquinone such as catechol and/or hydroquinone. Further, when the value for n is 3 and the value for m is 0 the compound of Formula I may be pyrogallol.

In an example, the compound of Formula I is not hydroquinone. Alternatively, the compound of Formula I may be hydroquinone.

Further, the one or more compounds of Formula I may comprise or consist of guaiacol. Additionally or alternatively, the one of more compounds of Formula I may comprise or consist of catechol.

The article may comprise or consist of an energy storage device or a part thereof. For example, the energy storage device may be a capacitor or a battery such as a rechargeable battery or a non-rechargeable battery. In a further example, the article may comprise or consist of a part of an energy storage device such as an electrode which may be a cathode or an anode. In still a further example, the article may be a conductive film such as a printable conductive film. In yet an example, the article may comprise or consist of an additive such as an additive for a filament for three dimensional printing, a coating such as paint, a material for carbonization, a bisphenol A substitute.

Additionally or alternatively, there is provided an article and/or lignin as described herein comprising or consisting of one or more of the following: a resin, plastic, composite, adhesive, concrete, surfactant, lubricant, fire-retardant, ionomer such as ion-exchange membranes or resins, sorption material such as sorption material for wastewater purification for removal of e.g. metal ions and/or organic compounds, coating, film, paint, pigment, dye, additive such as cosmetic additive or antioxidant additive, material for electrical and/or thermal insulation, filling material, a 3D printing material, composition for carbon fibers and/or production of activated carbons, lotion, ointment or cream for UV protection. In an example, the article and/or lignin described herein may be subjected to carbonization such as laser-assisted carbonization. In this way, the article and/or lignin may be made conductive. It will be appreciated that the article and/or lignin may be mixed with one or more additives prior to being subjected to carbonization. Alternatively, the article and/or lignin may be subjected to carbonization without being mixed with one or more additives. The carbonized article and/or lignin such as a carbonized material or carbonized film may be used in the following applications: in electrostatic discharge protection devices, as a heat sink component in electronic devices, as a part of anodes materials in energy storage, as a part of electrodes material for supercapacitors, as a support for the catalysts, as material for gas diffusion electrodes, as a part of static electricity dissipating component, as a friction reduction component, as a part of electromagnetic interfaces shielding.

While not wishing to be bound by any specific theory, it is believed that the lignin described herein may impart properties such as UV protection properties, photoresistance, antimicrobial properties, anti-fungal properties, anti-corrosion properties, sorption properties and/or water repellency.

In an example, the article is not a foam.

The lignin of the article may comprise or consist of lignin from biomass as described herein.

The invention also provides lignin covalently bonded to the one or more compounds of Formula I at the α position of the lignin β-O-4′ units as described herein. The lignin may be used for preparing an article such as an article described herein. Thus, there is provided the use of lignin covalently bonded to the one or more compounds of Formula I at the α position of the lignin β-O-4′ units for the preparation of an article.

The lignin described herein, such as the lignin of the article described herein, may comprise further compound(s) of Formula I in addition to the one or more compounds of Formula I binding covalently at the α position of the lignin β-O-4′ units. The further compound(s) of Formula I may bind covalently to the lignin at locations other than the α position of the lignin β-O-4′ units. Alternatively, the lignin described herein may be free or substantially free from such further compounds of Formula I.

There is also provided a method for preparing lignin covalently bonded at the α position of the β-O-4′ units to one or more compounds of Formula I as described herein. The method comprises the steps of:
a) mixing (i) an aqueous composition comprising biomass, an acidic pH adjuster, and optionally an organic solvent, and (ii) one or more compounds of Formula I as described herein thereby providing a mixture;
b) heating the mixture from step a) optionally followed by cooling thereby providing:
(i) lignin covalently bonded at the α position of the lignin β-O-4′ units to the phenyl ring of the one or more compounds of Formula I, wherein about 90% or more of the lignin β-O-4′ units bind at the α position to the one or more compounds of Formula I, and the lignin β-O-4′ units binding at the α position to the one or more compounds of Formula I are present within the range of from about 10% to about 50% per 100 C9 units of the lignin;
(ii) solid pulp comprising holocellulose,
(iii) (hemi) cellulose-derived sugars; and
c) optionally isolating the lignin comprising the one or more compounds of Formula I in step b) (i).

Step c) of the method may be present. Alternatively, step c) may be absent. Further, the method may comprise one or more additional steps of post-treatment such as mixing with one or more additives and/or carbonization as described herein.

In a further example, about 95% or more, such as about 97% or more, such as about 99% or more, such as all of the lignin β-O-4′ units bind at the α position to the one or more compounds of Formula I in step b) (i) of the method. Nuclear Magnetic Resonance (NMR) or any other suitable spectroscopic technique may be used for determining the percentage of lignin β-O-4′ units binding to the one or more compounds of Formula I.

Further, the lignin in step b) or c) of the method may comprise about 5% or less such as 0% of β-O-4′ units of Formula A, units of Formula B and/or units of Formula C as described herein.

The holocellulose may comprise lignin such as lignin in small amounts or be free from lignin. Further, the holocellulose and/or the (hemi) cellulose-derived sugars may be isolated so that they may be used further. Thus, there is provided holocellulose and/or (hemi) cellulose-derived sugars obtained or obtainable by the method.

The method described herein may involve extruder pulping, i.e. pulping including extrusion.

Conveniently, the method allows for functionalization of the lignin with the one or more compounds of Formula I without prior isolation of the lignin. Surprisingly, it has been found that the one or more compounds of Formula I may comprise several substituents such as two or three hydroxy groups and yet readily react with the lignin β-O-4′ units at the α position. This is illustrated in Scheme 1 for catechol as the compound of Formula I which provides the lignin fragment 2.

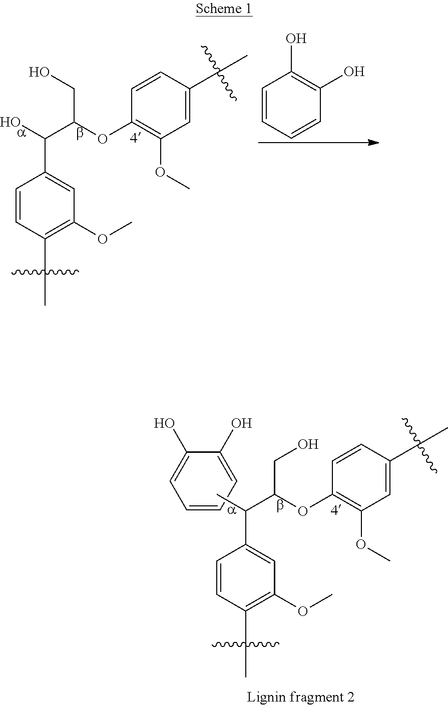

Examples of the lignin fragment 2 include lignin fragments 2A and 2B.

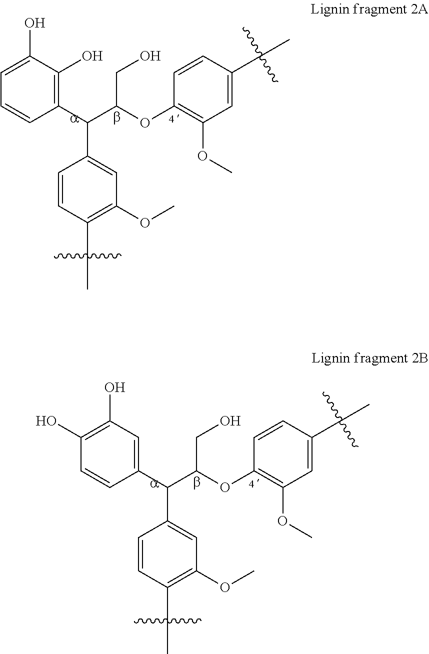 [SMILES: *c1ccc(OC(CO)C(c2ccc(*)c(OC)c2)c2cccc(O)c2O)c(OC)c1 ; *c1ccc(OC(CO)C(c2ccc(O)c(O)c2)c2ccc(*)c(OC)c2)c(OC)c1]

An organic solvent may be present in the method. For instance, the organic solvent may be one or more of the following: phenol, butanol, 1,4-dioxane, acetone, methanol, propanol, iso-propanol, ethanol, 2-methyltetrahydrofuran, methyl tert-butyl ether, cyclo-pentyl methyl ether, ethylene glycol, glycerol. For instance, the solvent may comprise or consist of phenol.

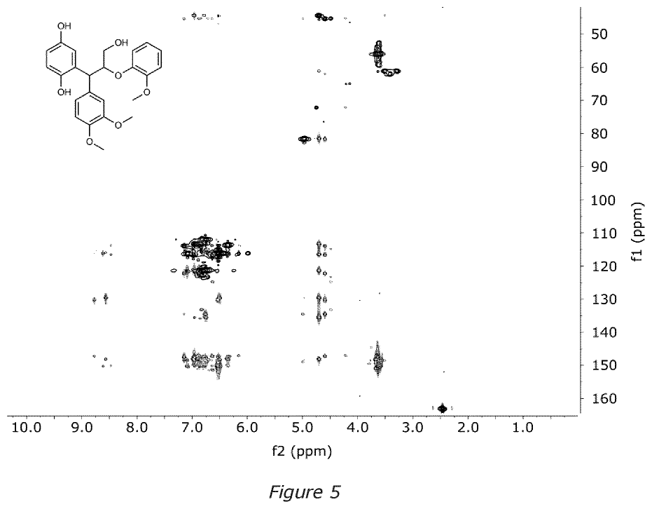

The mild reaction conditions of the method have surprisingly been found to provide lignin wherein all or substantially all of the β-O-4′ units bind at the α position to the phenyl ring of the one or more compounds of Formula I. For instance, about 90% or more, such as about 95% or more, such as about 99% or more of the lignin β-O-4′ units bind at the α position to the one or more compounds of Formula I. Thus, no or substantially no lignin β-O-4′ units remain unreacted at the α position. This is in contrast to running the method for a shorter period of time and at higher temperature which results in lignin wherein β-O-4′ units being unreacted at the α position remain as is shown in FIG. 5b in ACS Sustainable Chem. Eng. 2020, 8, 2772-2782.

Additionally, it has been found that the lignin β-O-4′ units binding at the α position to the one or more compounds of Formula I are present within the range of from 10% to 50% per 100 C9 units of the lignin. Thus, no or substantially no β-O-4′ units that are unreacted at the α position are present. This results in lignin with a well defined chemical structure and consequently controlled properties. Further, the method of the present invention results in very little (re) condensation of the lignin. As a result, the method of the present invention allows for preparing lignin with a high content of lignin β-O-4′ units binding at the α position to the phenyl ring of the one or more compounds of Formula I.

Further, it has surprisingly been found that the compound of Formula I, wherein m is not 0, may be used in a small amount in the presence of phenol such as phenol as solvent and yet allow for binding to the lignin α position to a large extent such as to a larger extent than the phenol. Of course, this is a significant benefit when compounds of Formula I having a high value are used since it improves the economic viability of the method and minimizes the need for recycling and/or disposal of the one or more compounds of Formula I.

The amount of the compound of Formula I in the method described herein may vary. For example, the amount of the compound of Formula I may be from 30 wt % to 80 wt % such as 50 wt % based on the total weight of the mixture.

The value of n for the compound of Formula I may be 2 or 3. Additionally or alternatively, m may be 0. Thus, in an example the compound of Formula I is not phenol.

Step b) of the method may be performed at a temperature from about 90° C. to about 200° C., such as from about 100° C. to about 190° C., from about 100° C. to about 180° C., from about 100° C. to about 170° C., from about 100° C. to about 150° C., from about 120° C. to about 150° C., from about 100° C. to about 120° C., from about 95° C. to about 105° C., from about 90° C. to about 100° C. The temperature may allow for reflux such as reflux temperature of the mixture. Additionally or alternatively, step b) of the method may be performed at ambient pressure such as atmospheric pressure or pressure higher than ambient pressure. For example, the pressure may be about 50 bar or less such as about 30 bar or less. Moreover, step b) may be performed during from about 0.1 hours to about 72 hours and/or during a time until the reaction has been completed as evidenced by monitoring using methods known in the art such as NMR or infrared spectroscopy (IR).

In an example, step b) of the method herein may be performed at
a temperature from about 90° C. to about 200° C., such as from about 90° C. to about 150° C., such as about 90° C. to about 120° C. such as about 90° C. to about 110° C.; and/or
ambient pressure such as atmospheric pressure or pressure higher than ambient pressure such as a pressure up to 5, 10, 15, 20, 25 or 30 bars; and/or from about 0.1 hours to about 72 hours such as from about 1.5 hours to about 5 hours.

In a particular example, step b) of the method may be performed at
a temperature from about 90° C. to about 110° C., from about 95° C. to about 105° C., from about 90° C. to about 100° C. or about 100° C.; and/or
ambient pressure such as atmospheric pressure or pressure higher than ambient pressure such as a pressure up to 5, 10, 15, 20, 25 or 30 bars; and/or
from about 1.5 hours to about 5 hours such as about 2 hours, about 3 hours or about 4 hours or during a time until the reaction has been completed as evidenced by monitoring using methods known in the art such as NMR or Infrared Spectroscopy (IR).

It will be appreciated that the method may be performed without pressurizing involving added external gas to the reaction vessel where the reaction is performed. However, the method may involve replacement of the gas in the reaction vessel where the method is performed with a gas, such as inert gas, such as nitrogen, followed by vessel closure and heating.

In an example, the method described herein may be performed in an open vessel at atmospheric pressure. Alternatively, the method may be performed in a closed vessel at atmospheric pressure or a pressure higher than atmospheric pressure such as a pressure equal or up to 5, 10, 15, 20, 25 or 30 bars.

The pH adjuster described herein may be an acidic pH adjuster, i.e. a pH adjuster providing an acidic pH. The acidic pH adjuster used in the method may be an acid or a salt thereof. The acidic pH adjuster may be a Brønsted acid and/or a Lewis acid. For instance, the acid or salt thereof may be one or more of the following acids: HCl, H₂SO₄, methanesulfonic acid, trifluoromethanesulfonic acid (HOTf), p-toluenesulfonic acid (p-TSA), FeCl₃, FeCl₂, AlCl₃, Fe(OTf)₃. In an example, the acid may be one or more of the following: HCl, H₂SO₄, methanesulfonic acid, trifluoromethanesulfonic acid (HOTf), p-toluenesulfonic acid (p-TSA.) For instance, the acid may be H₂SO₄. In a further example, the acid may be one or more of the following: FeCl₃, FeCl₂, AlCl₃. In still a further example, the pH adjuster may be provided as a salt of an acid such as Fe(OTf)₃. The pH adjuster may function as a catalyst to shorten the reaction time and may be added in an amount to provide a concentration of from about 0.01 M to about 0.5 M based on the total volume of the mixture. The amount of the acid may be from about 0.3 wt % to about 3.0 wt % based on the total weight of the mixture.

The biomass used in the method and/or article may comprise or consist of one or more of the following: hardwood, softwood, herbaceous biomass. Surprisingly, it has been found that all these sources of biomass can be successfully be used in the method of the present invention despite differences in e.g. their phenolic structure. This is a significant benefit, since it allows for flexibility for users who can choose the biomass with best access and suitability to them.

The biomass may be virgin biomass, side stream biomass such as waste biomass and/or energy crops. Virgin biomass includes terrestrial plants, such as trees, bushes and grass. Side stream biomass such as a waste biomass of low value by-product from various industrial sectors, such as agricultural side stream(s) or waste (e.g. corn stover, sugarcane bagasse, straw) and forestry side stream(s) or waste (e.g. sawdust, wood chips). In particular, the biomass described herein may comprise lignin having 30 or more, such as 35 to 45, β-O-4′ units per 100 C9 units of the lignin and/or is one or more of the following: hardwood, softwood, herbaceous biomass. Advantageously, the biomass comprises side streams such as sawdust and/or wood chips. It has been found that the method herein allows for using biomass side streams comprising pieces such as wood pieces or chips of varying size thereby minimizing or avoiding pre-treatment of the biomass side stream prior to use in the method.

In an example, the biomass comprises or is derived from hardwood and/or softwood trees comprising or lacking bark. For example, the hardwood and/or softwood trees may be one or more of the following: pine, spruce, fir, birch, beech, poplar, cedar, juniper, larch, redwood.

The biomass may be dried such as dried at a temperature below about 100° C., such as below about 65° C., prior to use. The water content of the biomass may be equal to or less than about 50 wt % such as about 20 wt % based on the total weight of the biomass. For instance, the water content of the biomass may be within the range of from about 0 wt % to 10 wt %, such as from 0 wt % to 5 wt %, based on the total weight of the biomass.

Further, the biomass may have a lignin content from 10 wt % to about 50 wt %, such as about 10 wt % to about 40 wt %, such as about 15 wt % to about 30 wt % based on the total weight of the biomass. For instance, the lignin content of the biomass may be from about 15 wt % to about 35 wt % or from about 15 wt % to about 30 wt % based on the total weight of the biomass. The lignin may be determined as Klason lignin as known in the art. It will be appreciated that the lignin content of the biomass may refer to dry weight content.

The biomass used in the method step a) may comprise, consist or be obtained from sawdust, wood chips, part of tree(s), sugarcane bagasse, ethanol production, biomass subjected to treatment involving removal of part or all of the hemicellulose, and any combination(s) thereof. Of course, it is an advantage that the method of the present invention allows for using the aforementioned biomass which is often considered to be waste and of little value.

The heating in step b) may be performed to a temperature as described herein to provide a mixture which may be in the form of a slurry.

The one or more compounds Formula I may be provided as a chemical in pure form.

Additionally or alternatively, the compound of Formula I may be provided as an organic material such as cashew nut shell oil, pyrolysis oil(s) (i.e. creosote) and/or tannin(s).

Advantageously, the method may be performed in air or in an atmosphere with reduced oxygen content. Alternatively, the method may be performed under inert atmosphere such as nitrogen or carbon dioxide. The use of an inert atmosphere may be desired for safety reasons when working on a large scale. Further, the use of an inert atmosphere may result in less coloring of the reaction mixture and carbohydrate residue.

The water content of the mixture of the method may vary from about 20 wt % to about 70 wt % based on the total weight of the mixture.

If present, the solvent may be added in an amount from about 1 kg to about 10 kg per kg of the biomass.

Step b) of the method may involve isolation of the solid pulp comprising holocellulose followed by isolation of the lignin covalently bonded to the one or more compounds of Formula I. This isolation of the lignin may take place using antisolvent precipitation and filtration, extraction, membrane filtration and/or any other suitable technique known in the art.

The average molecular weight of the lignin comprising the one or more compounds of Formula I described herein may be from about 1,500 g/moles to about 10,000 g/moles such as from about 2,500 g/moles to about 8,000 g/moles. Further, the lignin comprising the one or more compounds of Formula I may have a concentration of the one or more compounds of Formula I from about 1.5 g/mmol to about 3.0 g/mmol such as about 1.0 g/mmol or more or about 1.5 g/mmol or more.

There is also provided an article as described herein which is obtained or obtainable by the method of the present invention. Further, there is provided lignin as described herein that is obtained or obtainable by the method of the present invention.

It will be appreciated that the method of the present invention also allows for obtaining holocellulose and hemicellulose-derived sugars. Thus, there is provided holocellulose and/or hemicellulose-derived sugars obtained and/or obtainable by the method described herein.

The present disclosure also provides the following further aspects.

### FURTHER ASPECTS

### Further Aspect 1:

An article comprising:
(i) lignin; and
(ii) one or more compounds of Formula I:

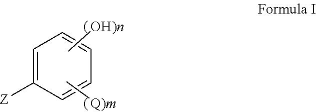

wherein
Q is independently selected from the group consisting of C₁-C₁₈alkyl, C₂-C₁₈alkene, OC₁-C₁₈alkyl, OC₂-C₁₈alkene, COOH, COOC₁-C₁₈alkyl, OCOC₁-C₁₈alkyl, COOC₂-C₁₈alkene, OCOC₁-C₁₈alkene, SO₃H and SH;
Z is H or

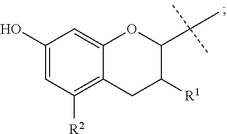

R¹ and R² are independently selected from the group consisting of H, OH, C₁-C₁₈ alkyl, C₂-C₁₈alkene and

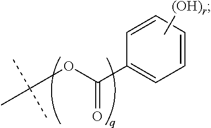

n is 1, 2 or 3;
m is 0, 1 or 2;
r is 2 or 3; and
q is 0 or 1
said lignin being covalently bonded at the α position of the lignin β-O-4′ units to the phenyl ring of the one or more compounds of Formula I;
wherein the one or more compounds of Formula I is/are present at the α position of the lignin β-O-4′ units within the range of from about 10% to about 50% per 100 C9 units of the lignin;
with the proviso that the article is not a foam.

### Further Aspect 2:

The article according to further aspect 1, wherein the compound of Formula I is not phenol.

### Further Aspect 3:

The article according to further aspect 1 or 2, wherein Z is H thereby forming a compound of Formula Ia:

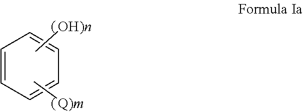

### Further Aspect 4:

The article according to further aspect 1 or 2, wherein
Z is

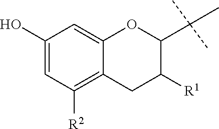

thereby forming a compound of Formula Ib:

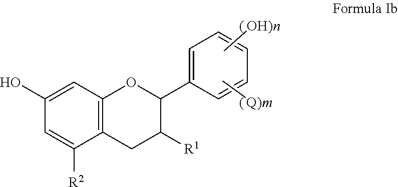

wherein R¹ and R² are as described herein
or a stereoisomer thereof.

### Further Aspect 5:

The article according to any one of the preceding further aspects, wherein the one or more compounds of Formula I is/are present at the α position of the lignin β-O-4′ units within the range of from about 20% to about 40%, such as from about 20% to about 35%, such as from about 25% to about 35%, such as about 30% per 100 C9 units of the lignin.

### Further Aspect 6:

The article according to any one of the preceding further aspects, wherein the compound of Formula I comprises one or more of the following: catechol, resorcinol, hydroquinone, pyrogallol, guaiacol.

### Further Aspect 7:

The article according to any one of the preceding further aspects, wherein n is 2 or 3 and m is 0.

### Further Aspect 8:

The article according to further aspect 7, wherein the compound of Formula I comprises one or more of: catechol, resorcinol, hydroquinone, pyrogallol.

### Further Aspect 9:

The article according to further aspect 7 or 8, wherein the compound of Formula I comprises or consists of catechol and/or hydroquinone.

### Further Aspect 10:

The article according to any one of the preceding further aspects, wherein the compound of Formula I is not hydroquinone.

### Further Aspect 11:

The article according to any one of the preceding further aspects, wherein the article comprises or consists of an energy storage device or part thereof.

### Further Aspect 12:

Lignin covalently bonded to the one or more compounds of Formula I as defined in any one of further aspects 2-11.

### Further Aspect 13:

Use of lignin as defined in further aspect 12 for the preparation of an article according to any one of further aspects 2-11.

### Further Aspect 14:

A method for preparing lignin covalently bonded to one or more compounds of Formula I as defined in further aspect 12, said method comprising the steps of:
a) mixing (i) an aqueous composition comprising lignocellulosic biomass, an acidic pH adjuster, and optionally an organic solvent, and (ii) one or more compounds of Formula I thereby providing a mixture;
b) heating the mixture from step a) optionally followed by cooling thereby providing:
(i) lignin covalently bonded at the α position of the lignin β-O-4′ units to the phenyl ring of the one or more compounds of Formula I, said one or more compounds of Formula I being present within a range of from about 10% to about 50% per 100 C9 units of the lignin;
(ii) solid pulp comprising holocellulose, and
(iii) (hemi) cellulose-derived sugars; and
c) optionally isolating the lignin comprising the one or more compounds of Formula I.

### Further Aspect 15:

The method according to any one of the preceding further aspects, wherein the organic solvent is present.

### Further Aspect 16:

The method according to further aspect 15, wherein the organic solvent is one or more of the following: phenol, butanol, 1,4-dioxane, acetone, methanol, propanol, iso-propanol, ethanol, 2-methyltetrahydrofuran, methyl tert-butyl ether, cyclo-pentyl methyl ether, ethylene glycol, glycerol.

### Further Aspect 17:

The method according to further aspect 15 or 16, wherein the organic solvent is phenol and the lignin bonded to the one or more compounds of Formula I comprises 67% or less of phenol at the α position of the β-O-4′ units per 100 C9 units of the lignin.

### Further Aspect 18:

The method according to any one of the preceding further aspects, wherein step b) is performed at
a temperature from 90° C. to 200° C.; and/or
ambient pressure or pressure higher than ambient pressure; and/or
during 0.1 hours to 72 hours.

### Further Aspect 19:

The method according to any one of the preceding further aspects, wherein the acidic pH adjuster comprises one or more of the following: HCl, H₂SO₄, p-toluenesulfonic acid (p-TSA), trifluoromethanesulfonic acid (HOTf), FeCl₃, AlCl₃, FeCl₂, Fe(OTf)₃.

### Further Aspect 20:

The method according to any one of the preceding further aspects, wherein the lignocellulose biomass comprises one or more of the following: hardwood, softwood, herbaceous biomass.

The invention will be further described by reference to the following examples, which are not intended to limit the scope of the invention.

### EXAMPLES

### Abbreviations

A ampere(s)

### BB Broad Band

cm centimeter(s)
CV cyclic voltammetry
DMF dimethylformamide

### DS Dry Substance

F farad
Fe(OTf)₃ iron (III) trifluoromethanesulfonate
g gram(s)
G guaiacol or coniferyl
GCD galvanostatic charge discharge
h hour(s)

### HMBC Heteronuclear Multiple Bond Correlation

HPLC High performance Liquid Chromatography

### HSQC Heteronuclear Single Quantum Coherence

### HQ Hydroquinone

GPC Gel permeation chromatography
kg kilogram(s)
mmol millimole(s)
Mₙ number average molecular weight
M_{w} weight average molecular weight

### LC Liquid Chromatography

M molar
min. minute(s)
mg milligram(s)
μM micromolar
mm millimeter(s)
mL milliliter(s)
μL microliter(s)
ND not determined
μm micrometer(s)
nm nanometer(s)
NHND endo-N-hydroxy-5-norbornene-2,3-dicarboximide
PLA polylactic acid
PP polypropylene
PTFE polytetrafluorethylene
rpm revolutions per minute
s. second(s)
THF tetrahydrofuran
TMDP 2-chloro-4,4,5,5-tetramethyl-1,3-2-dioxaphospholane
UV ultraviolet
wt % percent per weight
w/w weight by weight
Å Ångström

### General

All commercial chemicals were analytical reagents and were used without further purification. Phenol (liquified 80:20 w/w in water, general purpose grade, Fischer Chemical), Hydroquinone (99%, Acros Organics), Pyrogallol (98%+, Alfa Aesar), Catechol (≥99%, laboratory reagent grade, Fischer Chemical), Resorcinol (≥98%, FG, Merck), Sulfuric acid, ACS, 95-98% (Alfa Aesar), Hydrochloric acid 37% (Reag. Ph. Eur. VWR), phosphoric acid (BioUltra, ≥85% in water, Merck), p-toluenesulfonic acid monohydrate (≥99% Merck), acetone (GPR RECTAPUR VWR), ethanol (99.5%, analytical grade, Solveco), Carbon PBX51 (CABOT), graphite foil (SIGRAFLEX, F01513Z, SGL Carbon), chromium (III) acetylacetonate (97%, Merck), 2-Chloro-4,4,5,5-tetramethyl-1,3,2-dioxaphospholane (95%, Merck), endo-N-hydroxy-5-norbornene-2,3-dicarboximide (97%, Alfa Aesar), Polystyrene (low molecular) Standard ReadyCal Set (Merck), tetrahydrofuran (HPLC grade, unstabilized 99.8%, Fisher).

Pine wood (Pinus sylvestris) and spruce wood (Picea abies) of 30-100 years old trees was harvested in Svealand Sweden in 2021, the timber was debarked and processed at AB Karl Hedin Sågverk in Krylbo, Sweden. Fresh side streams of wood chips and sawdust were air dried before storage. Prior to experiments sawdust/wood chips were freeze dried and reduced in size to pass through a 1 mm mesh sieve, unless indicated otherwise.

Birch wood (Betula pendula) of 60-80 years old trees was harvested in Svealand Sweden in 2021, the timber was debarked and processed at Vanhälls Såg AB in Smedjebacken Sweden. Fresh side streams of wood chips and sawdust were air dried before storage. Prior to experiments sawdust/wood chips were freeze dried and reduced in size to pass through a 1 mm mesh sieve.

Bagasse from sugarcane (Saccharum officinarum) was collected after processing at Engenho tres irmaos in Tapera, Aquiraz Brazil. The sugarcane was pressed and the bagasse was air dried before transportation to Sweden. Prior to experiments the bagasse was freeze dried and reduced in size to pass through a 1 mm mesh sieve.

### Analytical Methods

Wood composition analysis was performed by MoRe Research Örnsköldsvik AB, Örnsköldsvik Sweden. The results are shown in Table 1 below. The carbohydrates were analyzed according to the method SCAN-CM 71:09 as described by the Scandinavian Pulp, Paper and Board testing committee in 2009, and were calculated as anhydro sugars. Hemicellulose and cellulose were calculated as % of carbohydrates. Further, the standard methods Tappi T222, Tappi T-UM 250 and ISO 638 were used as shown below in Table 1.

TABLE 1

| Analysis | Unit | Method | Pine | Spruce | Birch |
|---|---|---|---|---|---|
| Arabinose | g/kg | SCAN-CM | 16.8 | 10.2 | 2.9 |
| | DS | 71:09 | | | |
| Galactose | g/kg | SCAN-CM | 21.2 | 18.0 | 8.3 |
| | DS | 71:09 | | | |
| Glucose | g/kg | SCAN-CM | 414 | 428 | 387 |
| | DS | 71:09 | | | |
| Xylose | g/kg | SCAN-CM | 51.4 | 50.3 | 192 |
| | DS | 71:09 | | | |
| Mannose | g/kg | SCAN-CM | 110 | 111 | 14.2 |
| | DS | 71:09 | | | |
| Cellulose | % DS | | 61.6 | 63.4 | 63.0 |
| Hemicellulose | % DS | | 38.4 | 36.6 | 37.2 |
| Lignin, Klason | % DS | Tappi T222 | 26.9 | 26.5 | 19.6 |
| Lignin, | % DS | Tappi T-UM | 0.4 | 0.4 | 4.2 |
| Acid-soluble | | 250 | | | |
| Dry substance | % | ISO 638 | 89.6 | 88.7 | 96.1 |
| paper, pulp & | | | | | |
| board | | | | | |

Gel permeation chromatography (GPC) analysis was performed as follows:

Samples (~2.5 mg) were loaded in Agilent Technologies 0.45 UM PP mini-prep vials. THF (0.5 mL, unstabilized) was added and the sample(s) were shaken for 5 min., let to stand for 10 min, and then shaken again for 5 min. before the filters were pushed down (almost all material dissolved). The samples were then analyzed using a Hitachi HPLC Chromaster system equipped with two LC Phenogel columns 50 Å and 500 Å (5 μm, 7.8×300 mm each) connected in series (flow rate: 1 mL/min.; injection volume: 10 μL; solvent: THF), with a UV detector (280 nm) and auto-sampler. The system was calibrated using ReadyCal-Kit poly(styrene) (266, 682, 1250, 2280, 3470, 4920, 9130, 15700, 21500, 28000, 44200, 66000 g/mol). Samples of lignin were dissolved in THF and filtrated prior to analysis for safety reasons. Determination of Mn and Mw was done using Clarity Chromatography Software.

### NMR Analysis of Lignin ³¹P-NMR

The hydroxyl content was determined following the procedure in Nature Protocols, 2019, Vol 14, 2627-2647.

The modifiers, i.e. the compound(s) of Formula I, were analyzed using the same protocol to determine their specific OH signal regions. The different kinds of hydroxy (i.e. hydroxyls) are shown in Table 2.

TABLE 2

| | Aliphatic | Guaiacyl | Modifier | |
|---|---|---|---|---|
| | hydroxyls | hydroxyls | hydroxyls | |
| Modified Lignin | (δP) | (δP) | (δP) | Acids (δP) |
| Phenol-Lignin | 149.0-146.0 | 140.0-139.0 | 138.5-137.0 | 135.5-134.4 |
| Pyrogallol-Lignin | 148.5-145.0 | 140.0-139.0 | 144.5-141.5 | 135.8-134.4 |
| | | | 138.5-137.0 | |
| Resorcinol-Lignin | 149.0-145.2 | 140.0-139.1 | 139.1-135.9 | 135.8-134.4 |
| Catechol-Lignin | 148.0-146.5 | 140.0-139.0 | 138.9-138.2 | 135.8-134.4 |
| Hydroquinone- | 149.0-145.4 | 140.4-139.1 | 139.1-136.5 | 135.8-134.4 |
| Lignin | | | | |

### NMR Analysis of Lignin Using HSQC and HMBC

Approximately 100 mg of modified lignin was weighed in vials and 0.65 mL DMSO-d6 were added. The samples were dissolved by sonication at room temperature for 5 min. followed by pipetting the solution up and down, the cycle was repeated until all lumps were dissolved. The mixture was then transferred to 5 mm standard NMR tubes and analyzed on a Bruker AVANCE-III HD NMR system, 400 MHz Ascend standard-bore magnet with a SmartProbe: Broad band (BB)/¹H observe broadband probe head, diameter=5 mm, (BB=¹⁹F, ³¹P-¹⁵N), ¹H at 400.13 MHz and ¹³C at 100.61 MHz. Using the standard Bruker parameters for HSQC with the following modifications, number of scans 16, relaxation delay 1.5 s. Using the standard Bruker parameters for HMBC with the following modifications, number of scans 32, relaxation delay 1.5 s.

The amount of covalently bonded modifier at β-O-4′ linkages on the lignin was determined by NMR analysis of the lignin. Analysis was carried out by ¹H/¹³C HSQC NMR. The volume integrals of the benzylic (α position belonging to β-O-4′ linkage) ¹H-¹³C correlations for both the modified β-O-4′ linkages were compared to the sum of the volume integrals of the methoxy groups (CH₃O⁻) on the lignin aromatic components (adjusted for the number of protons). For softwood species the ratio of main lignin subunits (guaiacyl) was known (100%) and amount of methoxy groups per 100 C9 units was known. That in turn gave the number of β-O-4′ lignin linkages bearing modifier per 100 C9 units.

TABLE 3

| Modified Lignin | α proton (δC/δH) |
|---|---|
| Phenol-Lignin | 50.3/4.24 |
| Pyrogallol-Lignin | 43.6/4.61 |
| Resorcinol-Lignin | 43.0/4.60 |
| Catechol-Lignin | 50.5/4.15 |
| Hydroquinone- | 43.7/4.69 |
| Lignin | |

### Example 1

In this example, phenol was used to functionalize lignin as follows. A biomass to phenol ratio of 1 to 10 w/w was used. A 50 mL Kimax vial was loaded with 2.00 g±1.0 mg of pine wood (sawdust, freeze dried, milled and sieved through a 1 mm² sieve), phenol (stated percentage in w/w of total solvent mixture), water (stated percentage in w/w of total solvent mixture), acid (stated amount) and a bar-type polytetrafluorethylene (PTFE) coated stir bar. The acid was added last and the content was mixed at 1000 rpm. The vials were closed and heated in a pre-heated aluminum blocks at 100° C. for the stated time. Then reaction mixture was cooled to ambient temperature.

To the ambient tempered reaction mixture acetone (20 mL) was added and the pulp containing holocellulose was filtered off and washed with acetone (35 mL) by vacuum filtration through a Munktell grade 3 filter paper. The functionalized lignin containing filtrate was precipitated by dropwise addition to vigorously stirred deionized water (750 mL). The functionalized lignin was isolated by gravity filtration through a Munktell grade 3 filter paper and washed with water (300 mL). The resulting solid residue and the filter paper were freeze dried. Table 4 shows the conditions used and the obtained results, all experiments are duplicates.

TABLE 4

| | | | | | | Functionalized | |
|---|---|---|---|---|---|---|---|
| | | | | | | β-O-4′ | Mn, |
| | | | | Functionalized | | linkages per | g/mol |
| Ex. | H₂SO₄ | Time, | PhOH, | Lignin, | Pulp | 100 C9 units, | Mw, |
| No. | mmol | min. | wt % | (g) | (g) | (%) | g/mol |
| 1-1 | 2.4 | 120 | 60 | 0.387 | 1.054 | 33 | 1582 |
| | | | | | | | 3517 |
| 1-2 | 4.8 | 120 | 60 | 0.391 | 0.905 | 31 | 1658 |
| | | | | | | | 4246 |
| 1-3 | 2.4 | 180 | 60 | 0.406 | 1.024 | 30 | 1477 |
| | | | | | | | 3485 |
| 1-4 | 4.8 | 180 | 60 | 0.539 | 0.908 | 32 | 1569 |
| | | | | | | | 4272 |
| 1-5 | 2.4 | 300 | 60 | 0.551 | 0.954 | 34 | 1562 |
| | | | | | | | 4271 |
| 1-6 | 4.8 | 300 | 60 | 0.618 | 0.876 | 32 | 1583 |
| | | | | | | | 4644 |
| 1-7 | 2.4 | 870 | 60 | 0.686 | 0.859 | 32 | 1697 |
| | | | | | | | 4875 |
| 1-8 | 4.8 | 870 | 60 | 0.710 | 0.834 | 34 | 1443 |
| | | | | | | | 4307 |
| 1-9 | 2.4 | 1440 | 60 | 0.710 | 0.775 | 34 | 1406 |
| | | | | | | | 4131 |
| 1-10 | 4.8 | 1440 | 60 | 0.736 | 0.733 | 35 | 1226 |
| | | | | | | | 3485 |
| 1-11 | 2.4 | 300 | 50 | 0.357 | 1.058 | 27 | 1498 |
| | | | | | | | 3740 |
| 1-12 | 4.8 | 300 | 50 | 0.559 | 0.945 | 31 | 1618 |
| | | | | | | | 4741 |
| 1-13 | 2.4 | 300 | 60 | 0.551 | 0.954 | 34 | 1562 |
| | | | | | | | 4271 |
| 1-14 | 4.8 | 300 | 60 | 0.618 | 0.876 | 32 | 1583 |
| | | | | | | | 4644 |
| 1-15 | 2.4 | 300 | 70 | 0.643 | 0.869 | 33 | 1618 |
| | | | | | | | 4761 |
| 1-16 | 4.8 | 300 | 70 | 0.658 | 0.767 | 33 | 1706 |
| | | | | | | | 5120 |
| 1-17 | 2.4 | 300 | 80 | 0.683 | 0.791 | 35 | 1547 |
| | | | | | | | 4413 |
| 1-18 | 4.8 | 300 | 80 | 0.748 | 0.685 | 38 | 1368 |
| | | | | | | | 3680 |

From Table 4 it can be seen that change of the reaction conditions allowed to control degree of phenol incorporation, lignin fragments and holocellulose yield. In addition, the degrees of holocellulose pulp yields obtained indicate that efficient solubilization of hemicelluloses occurs during the process.

Table 4 shows that the obtained phenol functionalized lignin comprises a high proportion of phenol groups. It was also observed that the obtained phenol functionalized lignin comprises a high proportion of phenol substituted β-O-4′ linkages.

This is in contrast to typical lignins prepared by other methods where the β-O-4′ linkages originally present in the native lignin tend to be degraded such as fragmented, cleaved or (re) condensed. It was concluded that the present invention also provides modified lignin comprising at least 20% such as approximately 30% or more per 100 C9 units as determined by ¹H/¹³C-HSQC NMR. Further, it was estimated that 40-84% of all β-O-4′ linkages of the lignin present in the biomass starting material were successfully modified as it is known that native lignin in softwood typically contains from 45 to 50 β-O-4′ linkages per 100 C9 units. Furthermore, the present invention provided modified lignin where no native bonding motifs (i.e. no β-O-4′ linkages that are unsubstituted at the α position) were observable by ¹H/¹³C-HSQC NMR.

A semi-quantitative assessment of the amount of β-aryl ethers of the phenol functionalized lignin was performed. It was found that the obtained phenol functionalized lignin contained 20-38 β-O-4′ linkages per 100 C9 units. As a comparison, native lignin in hardwood comprises typically 50-65 β-O-4′ linkages per 100 C9 units. Further, as a comparison technical lignin is known to contain 0-10 β-O-4′ linkages per 100 C9 units and is therefore a less attractive starting material as it would provide lignin with a very low content of functionalized β-O-4′ linkages.

### Example 2

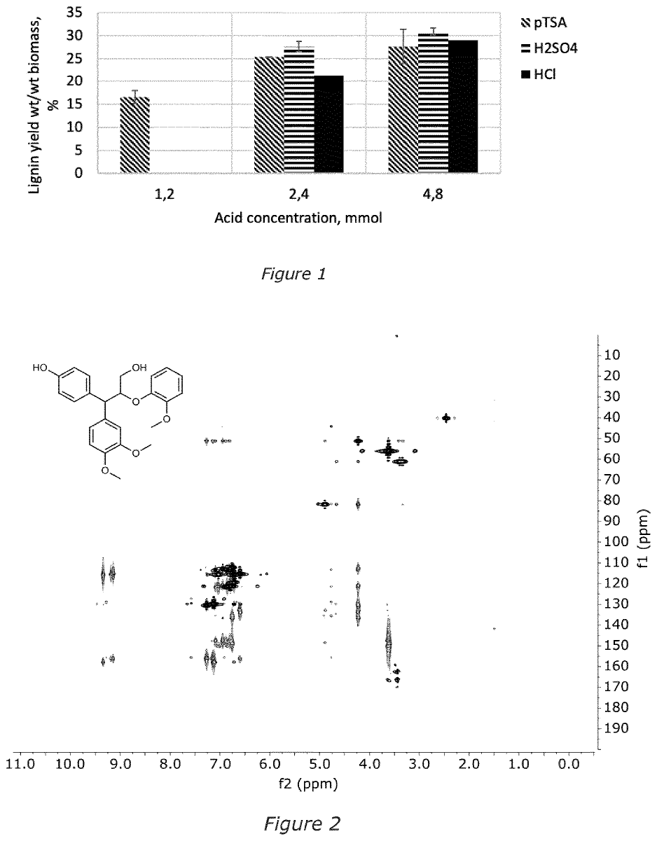

The procedure was carried out as in Example 1 using 2 grams of biomass, 60 wt % of phenol, a temperature of 100° C. for a time of 300 min. However, instead of sulfuric acid (H₂SO₄) each of the following acids were tested: hydrochloric acid (HCl), phosphoric acid (H₃PO₄), para-toluenesulfonic acid (p-TSA). The yield of phenol functionalized lignin based on the total weight of the biomass was measured. The results are shown in FIG. 1. Further, the percentage of phenol functionalized β-O-4′ linkages per 100 C9 units as determined by ¹H/¹³C-HSQC NMR was determined for the acids as shown in Table 5.

TABLE 5

| Amount of | Acid | | |
|---|---|---|---|
| acid | P = TSA | H₂SO₄ | HCl |
| (mmoles) | (%) | (%) | (%) |
| 1.2 | 30 | ND | ND |
| 2.4 | 34 | 34 | 30 |
| 4.8 | 36 | 32 | 34 |

It was observed from FIG. 1 that the best yield was obtained when using sulfuric acid. Good yields were also provided by p-TSA and HCl. Further, from Table 5 it was observed that p-TSA, sulfuric acid and hydrochloric acid allowed for more than 30% of phenol functionalized β-O-4′ linkages per 100 C9 units in isolated modified lignin fragments.

### Example 3

The procedure described in Example 1 was carried out using hydroquinone, pyrogallol, catechol, and resorcinol instead of phenol. The conditions and results are shown in Tables 6, 7, 8A, 8B, 9A and 9B. All experiments were performed during 300 min.

TABLE 6
Results for pyrogallol

| | | | | | Pyrogallol | | |
|---|---|---|---|---|---|---|---|
| | | | | | at β-O-4′ | Mₙ | |
| | | | | | per 100 | (g/mol) | |
| Ex. | H₂SO₄ | Pyrogallol | Lignin | Pulp | C9 units | M_{w} | Pyrogallol |
| No. | (mmol) | (wt %) | (g) | (g) | (%) | (g/mol) | (mmol/g) |
| 3-19 | 2.4 | 30 | 0.311 | 1.057 | 17 | 2829 | 2.27 |
| | | | | | | 7150 | |
| 3-20 | 2.4 | 40 | 0.347 | 1.795 | 17 | 2915 | 2.61 |
| | | | | | | 7186 | |
| 3-21 | 4.8 | 40 | 0.356 | 0.805 | 17 | 2630 | 2.47 |
| | | | | | | 6011 | |
| 3-22 | 2.4 | 50 | 0.365 | 0.825 | 19 | 3233 | 2.33 |
| | | | | | | 7162 | |
| 3-23 | 4.8 | 50 | 0.303 | 0.758 | 18 | 3244 | 2.40 |
| | | | | | | 5852 | |
| 3-24 | 4.8 | 60 | 0.192 | 0.817 | 20 | 2696 | 2.52 |
| | | | | | | 4753 | |

TABLE 7
results for resorcinol (resorcin.)

| | | | | | Resorcin. | | |
|---|---|---|---|---|---|---|---|
| | | | | | at β-O-4′ | Mₙ | |
| | | | | | per 100 | (g/mol) | |
| Ex. | H₂SO₄ | Resorcin. | Lignin | Pulp | C9 units | M_{w} | Resorcin. |
| No. | (mmol) | (wt %) | (g) | (g) | (%) | (g/mol) | (mmol/g) |
| 3-25 | 2.4 | 40 | 0.473 | 0.892 | 22 | 2027 | 2.48 |
| | | | | | | 3805 | |
| 3-26 | 4.8 | 40 | 0.461 | 0.842 | 23 | 2018 | 2.29 |
| | | | | | | 3576 | |
| 3-27 | 2.4 | 50 | 0.480 | 0.865 | 24 | 2237 | 2.24 |
| | | | | | | 3992 | |
| 3-28 | 4.8 | 50 | 0.443 | 0.830 | 24 | 1945 | 2.39 |
| | | | | | | 3397 | |
| 3-29 | 2.4 | 60 | 0.414 | 0.814 | 25 | 2151 | 2.48 |
| | | | | | | 3783 | |
| 3-30 | 4.8 | 60 | 0.346 | 0.774 | 24 | 1780 | 2.46 |
| | | | | | | 2883 | |

TABLE 8A
Results for catechol

| | | | | | Catechol | | |
|---|---|---|---|---|---|---|---|
| | | | | | at β-O-4′ | Mₙ | |
| | | | | | per 100 | (g/mol) | |
| Ex. | H₂SO₄ | Catechol | Lignin | Pulp | C9 units | M_{w} | Catechol |
| No. | (mmol) | (wt %) | (g) | (g) | (%) | (g/mol) | (mmol/g) |
| 3-31 | 2.4 | 40 | 0.371 | 1.010 | 30 | 2131 | 1.12 |
| | | | | | | 5433 | |
| 3-32 | 4.8 | 40 | 0.438 | 0.913 | 33 | 2308 | 1.21 |
| | | | | | | 6266 | |
| 3-33 | 2.4 | 50 | 0.439 | 0.925 | 32 | 2231 | 1.13 |
| | | | | | | 6016 | |
| 3-34 | 4.8 | 50 | 0.499 | 0.850 | 33 | 2343 | 1.27 |
| | | | | | | 6253 | |
| 3-35 | 2.4 | 60 | 0.474 | 0.885 | 32 | 2480 | 1.34 |
| | | | | | | 6321 | |
| 3-36 | 4.8 | 60 | 0.467 | 0.809 | 34 | 2449 | 1.72 |
| | | | | | | 5273 | |

TABLE 8B
Measurement of specific capacitance C(V) for catechol

| | | C(V), 0.2-0.8 |
|---|---|---|
| | Catechol | V, 0.75 A/g |
| Entry | (mmol/g) | (mAh/g) |
| 3-31 | 1.12 | 80 |
| 3-32 | 1.21 | ND |
| 3-33 | 1.13 | ND |
| 3-34 | 1.27 | ND |
| 3-35 | 1.34 | ND |
| 3-36 | 1.72 | 91 |

TABLE 9A
Results for hydroquinone (HQ.)

| | | | | | HQ at β-O-4′ | Mₙ | |
|---|---|---|---|---|---|---|---|
| | | | | | per 100 C9 | (g/mol) | |
| Ex. | H₂SO₄ | HQ | Lignin | Pulp | units | M_{w} | HQ |
| No. | (mmol) | (wt %) | (g) | (g) | (%) | (g/mol) | (mmol/g) |
| 3-37 | 2.4 | 40 | 0.107 | 1.277 | 20 | 1477 | 1.50 |
| | | | | | | 2337 | |
| 3-38 | 4.8 | 40 | 0.122 | 1.218 | 23 | 1542 | 1.66 |
| | | | | | | 2495 | |
| 3-39 | 2.4 | 50 | 0.276 | 1.098 | 22 | 1693 | 1.87 |
| | | | | | | 3109 | |
| 3-40 | 4.8 | 50 | 0.316 | 1.058 | 22 | 1755 | 1.99 |
| | | | | | | 3421 | |
| 3-41 | 2.4 | 60 | 0.377 | 0.992 | 22 | 1822 | 1.97 |
| | | | | | | 3671 | |
| 3-42 | 4.8 | 60 | 0.418 | 0.923 | 23 | 1842 | 2.17 |
| | | | | | | 3837 | |

TABLE 9B
Measurement of specific capacitance C(V) for hydroquinone (HQ)

| | | C(V), 0.2 | C(V), |
|---|---|---|---|
| | | 0.65 V, | 0.2-0.8 |
| | HQ, | 0.75 A/g | V, 0.75 |
| Entry | (mmol/g) | (mAh/g) | A/g (mAh/g) |
| 3-37 | 1.50 | 43 | 72 |
| 3-38 | 1.66 | 46 | 81 |
| 3-39 | 1.87 | 52 | 88 |
| 3-40 | 1.99 | 56 | 94 |
| 3-41 | 1.97 | 62 | 104 |
| 3-42 | 2.17 | 58 | 99 |

It was observed that the percentage of hydroquinone, pyrogallol, catechol, and resorcinol at β-O-4′ per 100 C9 units varied from 17% to 34%. Pyrogallol was found to afford the lowest percentage while catechol provided a percentage similar to that of phenol. Resorcinol, hydroquinone, and catechol all show a percentage that was higher than 20% of β-O-4′ linkages per 100 C9 units.

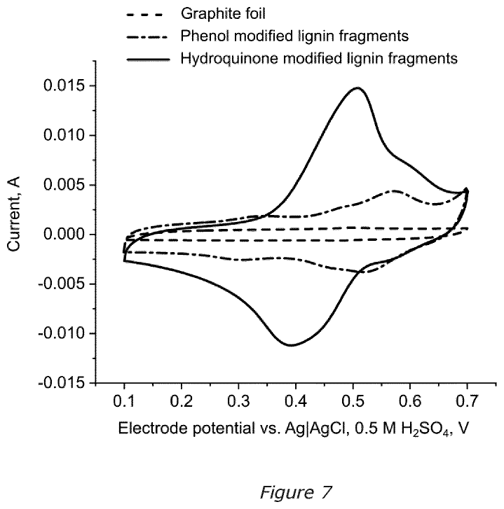

The specific capacitance was measured as described herein and the results are shown in Tables (8B and 9B, respectively) and it was observed that higher incorporation of covalently bound catechol or hydroquinone gives higher capacity. FIG. 7 shows the difference in capacity of hydroquinone modified lignin compared to phenol modified lignin.

### Example 4

To verify the structure of the obtained modified lignin fragments model compounds mimicking β-O-4′ linkages (100 mg) were subjected to the same reaction conditions (Phenol or Hydroquinone 60%, H₂SO₄ 4.8 mmol, 300 min., 100° C. or reflux) as lignocellulose composition (Example 1 and 3). The model compounds were the compounds A, B and C:

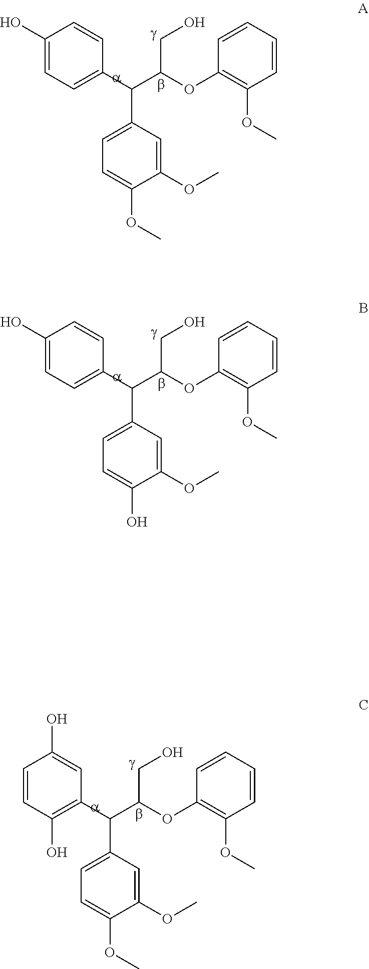 [SMILES: COc1ccc(C(c2ccc(O)cc2)C(CO)Oc2ccccc2OC)cc1OC ; COc1cc(C(c2ccc(O)cc2)C(CO)Oc2ccccc2OC)ccc1O ; COc1ccc(C(c2cc(O)ccc2O)C(CO)Oc2ccccc2OC)cc1OC]

The functionalized lignin of Example 1 may be depicted as compound D. The functionalized lignin of Example 3 may be depicted as compound E.

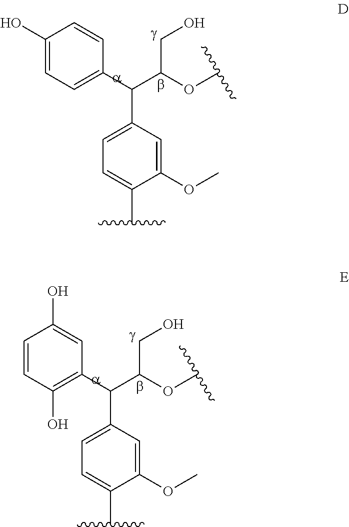 [SMILES: *OC(CO)C(c1ccc(O)cc1)c1ccc(*)c(OC)c1 ; *OC(CO)C(c1ccc(*)c(OC)c1)c1cc(O)ccc1O]

NMR spectra were recorded for the above compounds.

FIG. 2 shows the ¹H/¹³C HSQC/HMBC NMR spectrum for compound A. Overlay of ¹H/¹³C HSQC (in black) and HMBC (dotted line) shows the place of functional group connection.

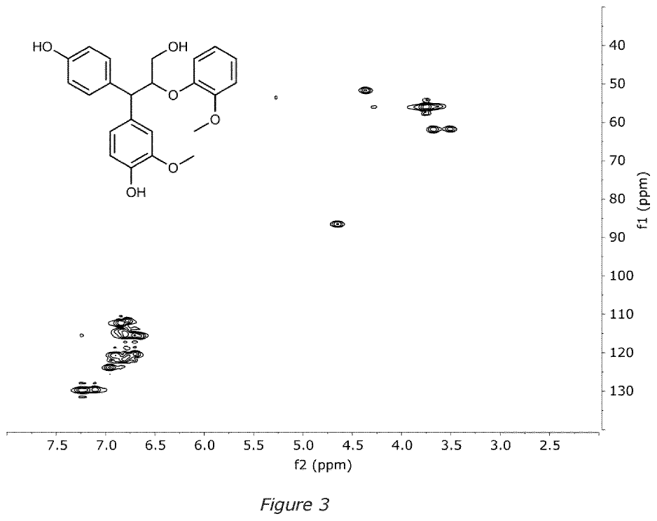

FIG. 3 shows the ¹H/¹³C HSQC NMR spectrum for compound B.

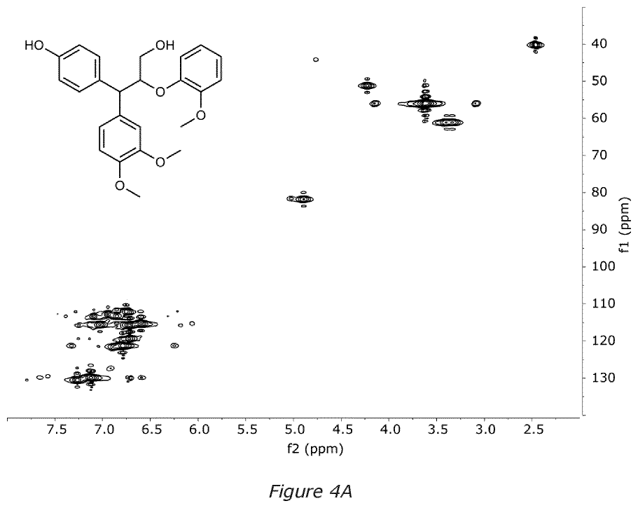

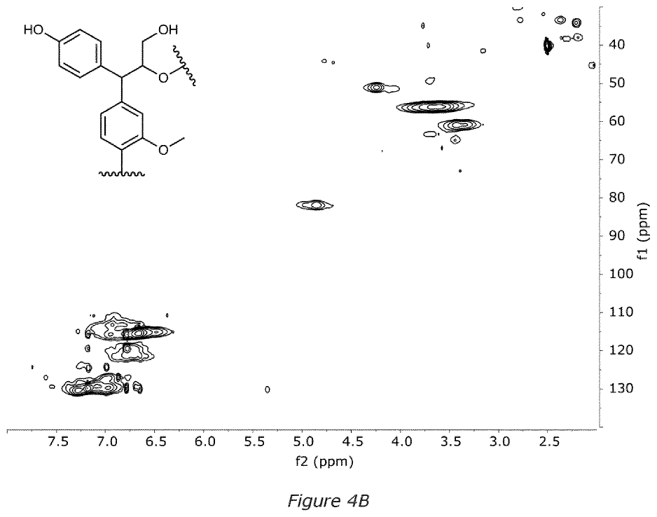

FIG. 4A shows the ¹H/¹³C HSQC NMR spectrum for compound A. FIG. 4B shows the ¹H/¹³C HSQC NMR spectrum for functionalized lignin D.

FIG. 5 shows the ¹H/¹³C HSQC/HMBC NMR spectrum for compound C. Overlay of ¹H/¹³C HSQC (in black) and HMBC (dotted line) shows the place of functional group connection.

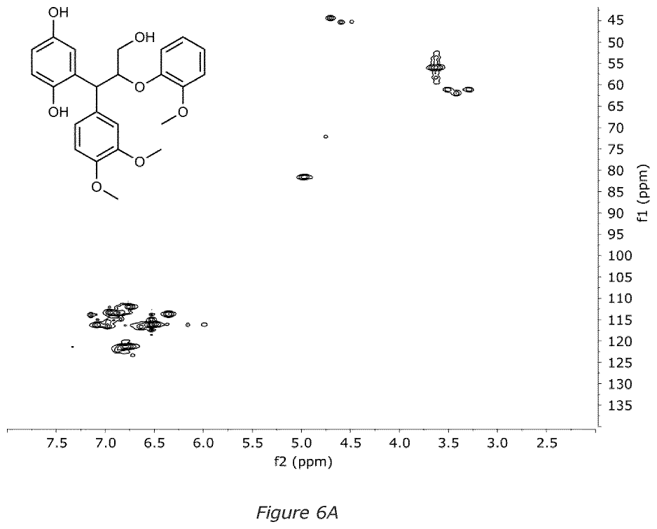

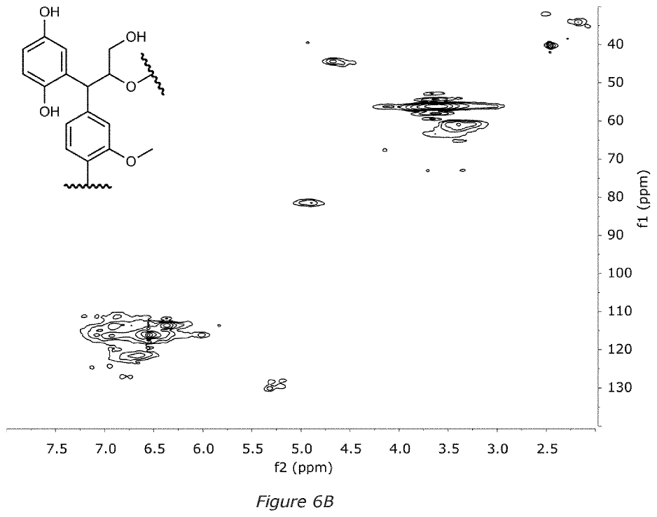

FIG. 6A shows the ¹H/¹³C HSQC NMR spectrum for compound C. FIG. 6B shows the ¹H/¹³C HSQC NMR spectrum for the functionalized lignin E.

Spectral data of the isolated modified products confirm formation of covalent bond between used modifier (i.e. phenol or hydroquinone) and the model compound at the α position of lignin. The obtained spectral data of the model compounds A, B and C was compared with spectral data of modified lignin fragments D and E where characteristic signals were the same confirming the same type of connection formed between the modifier and the lignin fragment.

The procedure was carried out as in Example 1 (using hydroquinone instead of phenol). Further, spruce, birch or bagasse derived lignocellulosic composition was used instead of pine. The reaction time was 300 min., the temperature was 100° C., the amount hydroquinone was 50 wt % and the amount of sulfuric acid was 4.8 mmol. The results are shown in Table 9C.

TABLE 9C

| | | | | | Hydroquinone | Mn |
|---|---|---|---|---|---|---|
| | | | | | at β-O-4′ per | (g/mol) |
| Ex. | H₂SO₄ | Hydroquinone | Lignin | Pulp | 100 C9 units | Mw |
| No | (mmol) | (wt %) | (g) | (g) | (%) | (g/mol) |
| 4-43 | 4.8 | 50 | 0.3265 | 1.057 | 23 | 2088 |
| | | | | | | 4559 |
| 4-44 | 4.8 | 50 | 0.285 | 0.8855 | 24* | 1610 |
| | | | | | | 2668 |
| 4-45 | 4.8 | 50 | 0.2565 | 0.801 | 17* | 1430 |
| | | | | | | 2456 |

Table 9 shows isolated functionalized lignin fragments from spruce (entry 4-43), birch (entry 4-44), and sugarcane bagasse (entry 4-45) lignocellulose biomass. * Due to the lignin structure birch and bagasse also contain other than guaiacyl lignin subunits (additionally syringyl for birch, and additionally p-hydroxyphenyl and syringyl for bagasse) and therefore the value is given for methoxy group signals normalized to 3, for comparison purposes. Assuming birch S/G ratio, i.e. the syringyl/guaiacil ratio, equals 3, the degree of modification instead of 24% for birch will be 44%. Assuming bagasse average lignin composition as G/S/H ratio, i.e. guaiacil/syringyl/p-hydroxyphenyl ratio, is 1.5/1/1 modification degree will also be approximately 44%.

It was concluded that the method of the present disclosure can be successfully applied to obtain functionalized lignin fragments from biomasses such as softwood, hardwood, and bagasse.

### Example 5

Modifiers, i.e. compounds of Formula I as described herein, can be very expensive. Therefore, it is advantageous to have a possibility to minimize amount of the modifier being used to perform lignin modification. In this example, the same reaction conditions as in Example 1 were used. However, part of the phenol was replaced with resorcinol and pyrogallol, respectively. 45% of phenol and 15% of resorcinol or pyrogallol were used. The reaction time was 300 min. Analysis of the isolated functionalized lignin fragments showed that successful modification of lignin had taken place at the α position. The results are shown in Table 10 and Table 11. It was observed that resorcinol and pyrogallol were nearly exclusively connected to the lignin fragments despite being used in considerably lower amount than phenol.

TABLE 10

| | | | | | | Phenol | Pyrogallol |
|---|---|---|---|---|---|---|---|
| | | | | | | at β-O-4′ | at β-O-4′ |
| | | | | | | per 100 | per 100 |
| Ex. | H₂SO₄ | Phenol | Pyrogallol | Pulp | Lignin | C9 units | C9 units |
| No. | (mmol) | (wt %) | (wt %) | (g) | (g) | (%) | (%) |
| 6-47 | 4.8 | 45 | 15 | 0.868 | 0.222 | 2 | 20 |

TABLE 11

| | | | | | | Phenol | Resorcinol |
|---|---|---|---|---|---|---|---|
| | | | | | | at β-O-4′ | at β-O-4′ |
| | | | | | | per 100 | per 100 |
| Ex. | H₂SO₄ | Phenol | Resorcinol | Pulp | Lignin | C9 units | C9 units |
| No | (mmol) | (wt %) | (wt %) | (g) | (g) | (%) | (%) |
| 6-46 | 4.8 | 45 | 15 | 0.827 | 0.336 | 2 | 26 |

### Example 6

A graphite foil (Sigraflex F01513Z) was used as current collector for working electrode, while Pt wire and Ag|AgCl saturated electrode were used as auxiliary and reference electrodes for three-electrode geometry cells, respectively. A working electrode was prepared according to the following procedure. The graphite foil was cut and washed with acetone and distilled water three times, dried at 80° C. for 15 min, and then at 120° C. for 10 min. Electrodes were cooled down to room temperature (i.e. 20-22° C.) and weighed. For the slurry preparation, functionalized lignin fragments (~30 mg) were dissolved in 0.5 mL of DMF using Vortex and ultrasonication to ensure full dissolution. Then carbon black (PBX51) was added to the solution in a ratio 50:50 w/w (PBX51: functionalized lignin fragments). The resulting dispersion was additionally dispersed using vortex and ultrasonication. Graphite electrodes were coated with the slurry through wet casting and then dried at 130° C. to remove the solvent. Casting procedure was repeated until the mass of redox active material (functionalized lignin fragments) reached 1-4 mg. The lignin was functionalized with phenol and hydroquinone, respectively. Prepared electrodes were dried until constant mass and weighed. The electrochemical characteristics of different lignin macromolecules were measured in 0.5 M aqueous solution of H₂SO₄ under nitrogen inert atmosphere. The following cycling protocol was used: 10 cycles between 0.20 and 0.65 V at scan rate of 5 mV/s in CV mode, 2 cycles at 5, 2.5, 1, 0.75 A/g between 0.20 and 0.65 V in GCD mode, 3 cycles between 0.20 and 0.65 V in CV mode, 10 cycles between 0.20 and 0.80 V in CV mode, 2 cycles at 5, 2.5, 1, 0.75 A/g between 0.20 and 0.80 V in GCD mode. The specific capacity and characteristics of electrochemical reactions were investigated by CV method, while expected specific capacitance of electrode was calculated from GCD data. Both the specific capacity in CV and specific capacitance in GCD experiments were calculated according to the equations (1) and (2), respectively. All data were collected using Autolab PGSTAT302 N potentiostat (Electrochemie, Netherlands).

$${C}_{sp} = \frac{∮ idu}{2 Δ {U𝔪V}_{s}} \qquad Equation ( 1 )$$

where Cₛₚ is specific capacity of active material (F/g); i is the current (A); du is differentially small increment of potential (V); ΔU is a potential window (V); Vs is the scan rate (mV/s); m is the mass of the electrode active material, (g).

$$C ( V ) = \frac{t ( V ) {I}_{s}}{3600} \qquad Equation ( 2 )$$

Where C(V) is a specific capacitance at defined potential (mA·h/g); t (V) is the time at the defined potential(s); Iₛ is the applied specific current (A/g).

FIG. 7 shows the current as a function of the electrode potential. It was observed that the lignin functionalized with hydroquinone had a higher specific capacity as compared to the lignin functionalized with phenol.

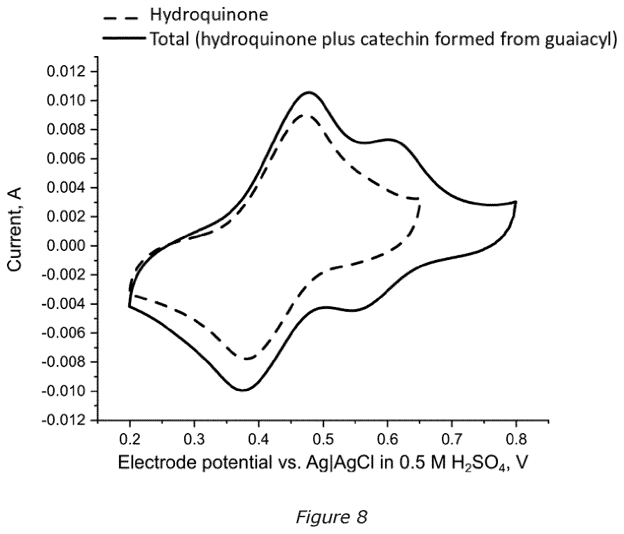

FIG. 8 shows the current as a function of the electrode potential for lignin functionalized with hydroquinone before and after activation of catechin groups, i.e. catechol bonded groups. It was observed that Cₛₚ=363 F/g or C(V)=56 mA·h/g (0.2-0.8 V at 0.75 A/g) were provided from the hydroquinone groups (Entry 40, Table 8) while additionally 96 F/g or 38 mA·h/g were provided from the catechin groups, what in total accounts for Cₛₚ=459 F/g or C(V)=94 mA·h/g.

It was observed that no binder was required as the functionalized lignin fragments and carbon black were sufficient to coat the electrode. This means that the material can function as an active redox binder material.

### Example 7

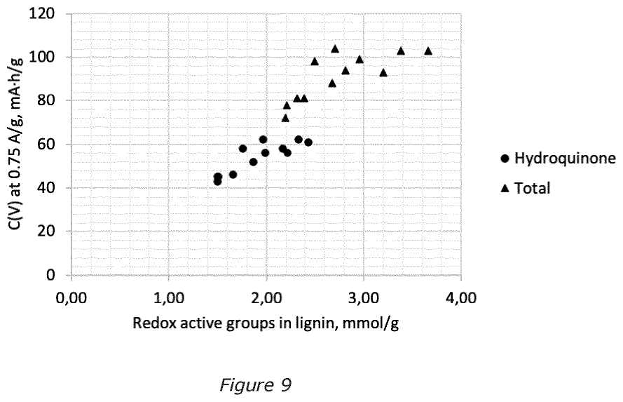

The procedure described in Example 1 was carried out using hydroquinone instead of phenol. The conditions and results are shown in Table 12A. The time of the treatment was varied. The amount of hydroquinone was 50 wt % for all examples. It was observed from Table 12A that the better the yield was for lignin the lower the yield was for pulp. It was observed that with longer reaction time higher amount of hydroquinone incorporation took place. 21% of hydroquinone functionalized β-O-4′ linkages per 100 C9 units in isolated modified lignin fragments was observed at 300 min. reaction time and 22% at 720 min. Table 12B shows measurements for an electrode in the same way as in Example 7. FIG. 9 shows the specific capacitance as a function of amount of redox active groups for the hydroquinone functionalized lignin. FIG. 9 and Table 12B shows capacitance of the material in two different regions: from 0.20 to 0.65 V and from 0.20 to 0.80 V. From 0.20 to 0.65 V only hydroquinone was redox active. From 0.20 to 0.80 V both hydroquinone and catechol groups were redox active. Catechol groups were formed under experiment conditions from guaiacol groups that are a part of native lignin structure. Table 12B shows the concentration of hydroquinone and guaiacol groups measured by ³¹P NMR. It was observed that higher amount of redox active groups gives higher specific capacitance.

TABLE 12A

| | | | | | Hydroquinone | | Mn, |
|---|---|---|---|---|---|---|---|
| | | | | | at β-O-4′ per | | (g/mol) |
| Ex. | H₂SO₄ | Time | Lignin | Pulp | 100 C9 units | HQ, | Mw, |
| No. | (mmol) | (min.) | (g) | (g) | (%) | (mmol/g) | (g/mol) |
| 8-48 | 4.8 | 60 | 0.206 | 1.267 | 19 | 1.50 | 1376 |
| | | | | | | | 2249 |
| 8-49 | 4.8 | 180 | 0.298 | 1.156 | 21 | 1.51 | 1560 |
| | | | | | | | 2824 |
| 8-50 | 4.8 | 300 | 0.393 | 1.108 | 21 | 2.22 | 1691 |
| | | | | | | | 3165 |
| 8-51 | 4.8 | 720 | 0.401 | 0.996 | 22 | 1.76 | 1669 |
| | | | | | | | 3303 |
| 8-52 | 4.8 | 1440 | 0.454 | 0.855 | 21 | 2.33 | 1685 |
| | | | | | | | 3459 |
| 8-53 | 4.8 | 2880 | 0.543 | 0.732 | 18 | 2.43 | 1546 |
| | | | | | | | 2973 |

TABLE 12B

| | | | C(V), | C(V), |
|---|---|---|---|---|
| | | | 0.20 = | 0.20- |
| | | | 0.65 V, | 0.80 V, |
| Ex. | HQ | G | 0.75 A/g | 0.75 A/g |
| No. | (mmol/g) | (mmol/g) | (mAh/g) | (mAh/g) |
| 8- | 1.50 | 0.82 | 45 | 81 |
| 48 | | | | |
| 8- | 1.51 | 0.70 | 45 | 78 |
| 49 | | | | |
| 8- | 2.22 | 0.98 | 56 | 93 |
| 50 | | | | |
| 8- | 1.76 | 0.74 | 58 | 98 |
| 51 | | | | |
| 8- | 2.33 | 1.05 | 62 | 103 |
| 52 | | | | |
| 8- | 2.43 | 1.23 | 61 | 103 |
| 53 | | | | |

### Example 8

A microscope slide made from soda lime glass was used as a support for coating. Coating was prepared according to the following procedure. Phenol functionalized lignin fragments prepared, wherein the lignin had been prepared in accordance with Example 1, (400 mg) were dissolved in 0.5 mL dimethylformamide. After full dissolution of the lignin fragments in the dimethylformamide boric acid 0.9 M water solution (0.215 mL) was added. The obtained mixture was deposited onto glass using micrometer film applicator to provide a film having a thickness of 120 μm, air dried for 5 min and then oven dried at 70° C. for 30 minutes. Laser irradiation was conducted under ambient atmosphere using laser engraver (40 W CO2 laser Beabbox, Flux, USA). Irradiation was conducted at laser power of 8 W (20% power of maximum power) and at the speed of 50 mm/s and a laser spot size of 0.2 mm. Applied irradiation led to formation of carbonized conductive film with resistivity c.a. 2.10-5 (2/m. Thus, functionalized lignin prepared in accordance with the present disclosure allowed for preparing a conductive material such as a conductive film.

### Example 9

Thermogravimetric analysis of phenol functionalized lignin fragments, wherein the lignin had been prepared in accordance with Example 1, was carried out using a Mettler Toledo TGA/SSD instrument. The sample (~14 mg) was placed in an inert ceramic crucible and heated from 25° C. to 120° C. (temperature was kept at 120° C. for 30 min) then 450, 600, or 700° C. at heating rates of 2,5, 7 or 10° C./min under N₂ gas flow of 60 mL/min. The sample was maintained at chosen temperatures of 450, 600, or 700° C. for 1 h. This led to carbonization. Carbonized material was obtained after the analysis in the following yields:

| | 2° C./min | 5° C./min | 7° C./min | 10° C./min |
|---|---|---|---|---|
| 450° C. | ND | 40.9% | ND | ND |
| 600° C. | 35.7% | 33.7% | ND | 33.2% |
| 700° C. | 33.4% | 32.7% | 32.5% | 31.7% |

A scale-up experiment was performed in a quartz tube furnace. Modified lignin prepared in accordance with Example 1 (450 mg) was placed in a ceramics boat into the furnace. After sealing the quartz tube furnace, it was flashed with N₂ gas for 30 min to replace air. Then the tube was heated up to 120° C. and maintained at that temperature for 30 min. Then it was heated to 700° C. at 2 or 5° C./min heating rates. When the set temperature was reached the sample was maintained at that temperature for 1 h. Then the quartz tube furnace was cooled down. The yield of the carbonized material was 148 mg and 144 mg which was close to the results of thermogravimetric analysis namely 33 wt % and 32 wt %. The conductivity of the materials reached ~50-70 Ohms according to the manual measurements taken with Ohmmeter, where probes were placed onto material at the distance of c.a. 1 cm.

### Example 10

Filaments for fused deposition modeling were produced using Filabot EX2 single screw extruder (Filabot Inc., Barre, VT, USA) at 180° C. Pelletized industrial PLA filament (Industrial PLA filament (Silver PLA filament) was purchased from Prusa Polymers a.s., Prague, Czech Republic) and phenol functionalized lignin fragments, wherein the lignin had been prepared in accordance with Example 1 were dried overnight at 70° C. prior to mixing and extrusion. Functionalized lignin and polylactic acid (PLA) filaments were mixed in the weight to weight ratios of 3 to 7, 1 to 1, or 7 to 3, weight to weight. After the first extrusion the filaments were pelletized and extruded a second time to achieve filaments comprising a more homogeneous material. Type V (five) dog-bone specimens (standard test method was ASTM D638) were printed using the produced filaments on Prusa i3 MK3S printer (Prusa, Prague, Czech Republic) equipped with a 0.4 mm diameter nozzle. The printing and bed temperature were 215° C. and 60° C., respectively. The specimens had a layer height of 0.15 mm and 15% infill. As used herein, infill or infill density refers to the amount of space filled inside the object.

All filaments with different amount of functionalized lignin (from 30 to 70 wt %) demonstrated printability. Thus, filaments comprising functionalized lignin in accordance with the present disclosure can be used for printing.

### Example 11

In this example, phenol was used to functionalize lignin as follows. A 3 L three necked round bottom flask was loaded with 440.0 g #0.1 g of pine wood (sawdust as obtained from AB Karl Hedin Sågverk in Krylbo, Sweden, (circular saws), air dried (moisture 10 wt %)), phenol 1200 g, water 760 g, acid 40 g (12 M H₂SO₄) and equipped with reflux condenser and polytetrafluorethylene (PTFE) coated mechanical stirrer. The pine wood sawdust in this example contained sawdust pieces of varying sizes. The largest sawdust pieces measured 2 cm×3 cm×0.4 cm. Other sawdust pieces were found to measure e.g. 0.2 cm×0.2 cm×0.1 cm and 0.4 cm×5 cm×0.1 cm. The pine wood sawdust was not subjected to any further pre-treatment such as cutting or the like. The acid was added last and the content was mixed at 300 rpm. The flask was heated in a heating mental to reflux started (20 min). Reflux temperature was 100° C. Reaction was maintained under reflux for 5 h. The reaction mixture was then taken off heating and cooled to ambient temperature. It was observed that all sawdust pieces had been pulped. Reaction mixture was treated in accordance with example 1. Phenol modified lignin was obtained in an amount of 103.5 g. Phenol-Lignin was analyzed according to the standard ³¹P NMR method: guaiacyl hydroxyls 0.49 mmol/g, phenol 2.6 mmol/g. The amount of covalently bonded phenol at β-O-4′ linkages on the lignin was determined by NMR analysis of the lignin: 30 linkages per 100 C9 units. No native bonding motifs (i.e. no β-O-4′ linkages that are unsubstituted at the α position) were observed. It was concluded that side stream biomass such as sawdust could successfully be used as a starting material in the method of the present invention. Further, it was concluded that the method of the present invention allows for processing side stream biomass pieces such as sawdust of varying sizes.

### REFERENCES

1. US 2021/0130554 A1
2. EP 3 808 755 A1
3. ACS Sustainable Chem. Eng. 2020, 8, 2772-2782
4. Nature Protocols, 2019, Vol 14, 2627-2647

1-34. (canceled)

35. Lignin covalently bonded to one or more compounds of Formula I: 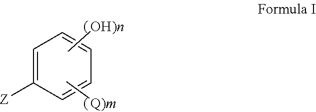
wherein
Q is independently selected from the group consisting of C₁-C₁₈alkyl,
C₂-C₁₈alkene, OC₁-C₁₈alkyl, OC₂-C₁₈alkene, COOH, COOC₁-C₁₈alkyl, OCOC₁-C₁₈alkyl, COOC₂-C₁₈alkene, OCOC₁-C₁₈alkene, SO₃H and SH;
Z is H or 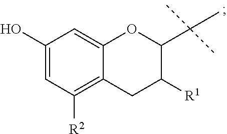
R¹ and R² are independently selected from the group consisting of H, OH, C₁-C₁₈ alkyl, C₂-C₁₈alkene and 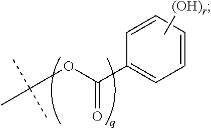
n is 1, 2 or 3;
m is 0, 1 or 2;
r is 2 or 3; and
q is 0 or 1
said lignin being covalently bonded at the α position of the lignin β-O-4′ units to the phenyl ring of the one or more compounds of Formula I, said bonding providing functionalized lignin fragment 1 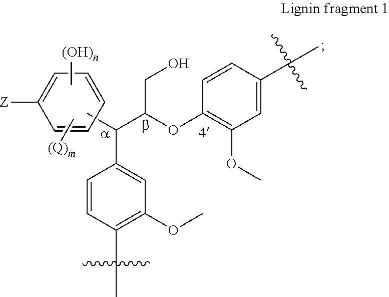
wherein
all of the lignin β-O-4′ units bind at the α position to the phenyl ring of the one or more compounds of Formula I; and
the lignin β-O-4′ units binding at the α position to the phenyl ring of the one or more compounds of Formula I are present within the range of from 10% to 50% per 100 C9 units of the lignin.

36. The lignin according to claim 35, wherein the lignin comprises
0% of units of Formula B and units of Formula C 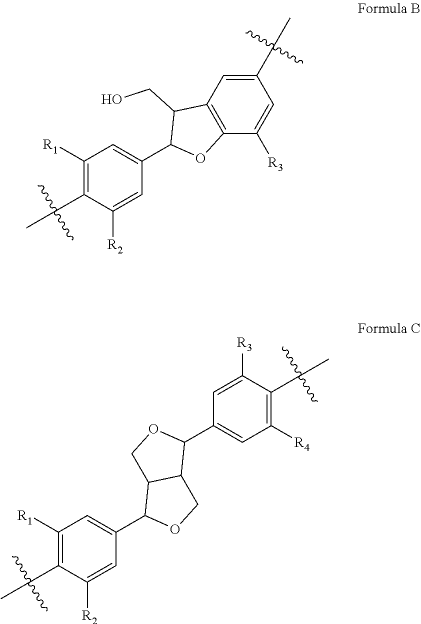
wherein R₁, R₂, R₃ and R₄ independently are H or OCH₃.

37. The lignin according to claim 35, wherein Nuclear Magnetic Resonance (NMR) is used for determining the percentage of lignin β-O-4′ units binding to the one or more compounds of Formula I.

38. The lignin according to claim 35 wherein the one or more compounds of Formula I is not phenol.

39. The lignin according to claim 35, wherein the lignin is lignin from biomass having 30 or more β-O-4′ units per 100 C9 units of the lignin and having a lignin content from 10 wt % to 50 wt %.

40. The lignin according to claim 35, wherein the compound of Formula I is a compound of Formula Ia:

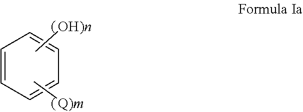

41. The lignin according to claim 35, wherein the compound of Formula I is a compound of Formula Ib: 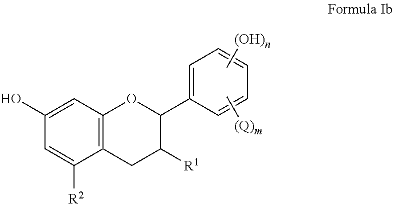
or a stereoisomer thereof.

42. The lignin according to claim 35, wherein the one or more compounds of Formula I comprise(s) one or more of: catechol, resorcinol, hydroquinone, pyrogallol, guaiacol.

43. The lignin according to claim 35, wherein n is 2 or 3 and m is 0.

44. The lignin according to claim 35, wherein the one or more compounds of Formula I comprise(s) one or more of: catechol, resorcinol, hydroquinone, pyrogallol.

45. The lignin according to claim 35, wherein the lignin β-O-4′ units binding at the α position to the one or more compounds of Formula I are present within the range of from 20% to 40% per 100 C9 units of the lignin.

46. The lignin according to claim 35, wherein the lignin β-O-4′ units binding at the α position to the one or more compounds of Formula I are present within the range of from 20% to 35% per 100 C9 units of the lignin.

47. The lignin according to claim 35, wherein the lignin β-O-4′ units binding at the α position to the one or more compounds of Formula I are present within the range of from 25% to 35% per 100 C9 units of the lignin.

48. A method for preparing lignin covalently bonded at the α position of the β-O-4′ units to one or more compounds of Formula I as defined in claim 35, said method comprising the steps of:
a) mixing (i) an aqueous composition comprising or consisting of biomass, an acidic pH adjuster, and optionally an organic solvent, and (ii) the one or more compounds of Formula I thereby providing a mixture,
said pH adjuster being an acid that is present in an amount from 0.3 wt % to 3.0 wt % based on the total weight of the mixture;
b) heating the mixture from step a) optionally followed by cooling thereby providing:
(i) lignin covalently bonded at the α position of the lignin β-O-4′ units to the phenyl ring of the one or more compounds of Formula I, wherein all of the lignin β-O-4′ units bind at the α position to the one or more compounds of Formula I, and the lignin β-O-4′ units binding at the α position to the phenyl ring of the one or more compounds of Formula I are present within the range of from 10% to 50% per 100 C9 units of the lignin;
(ii) solid pulp comprising holocellulose,
(iii) (hemi) cellulose-derived sugars; and
c) isolating the lignin comprising the one or more compounds of Formula I in step b) (i).

49. The method according to claim 48, wherein step b) is performed at
a temperature from 90° C. to 200° C.; and/or
atmospheric pressure or pressure higher than atmospheric pressure; and during a time until the reaction has been completed as evidenced by monitoring using methods known in the art such as Nuclear Magnetic Resonance (NMR) or infrared spectroscopy (IR).

50. The method according to claim 49, wherein step b) is performed at
a temperature from 90° C. to 110° C.; and/or
atmospheric pressure or pressure higher than atmospheric pressure; and during a time until the reaction has been completed as evidenced by monitoring using methods known in the art such as Nuclear Magnetic Resonance (NMR) or infrared spectroscopy (IR).

51. The method according to claim 48, wherein the biomass comprises lignin having 30 or more β-O-4′ units per 100 C9 units of the lignin and/or is one or more of the following: hardwood, softwood, herbaceous biomass.

52. An article comprising the lignin according to claim 35.
